(19) United States
(12) Patent Application Publication
(10) Pub. No.: US 2012/0269451 A1
(43) Pub. Date: Oct. 25, 2012

(54) INFORMATION PROCESSING APPARATUS, INFORMATION PROCESSING METHOD AND PROGRAM

(76) Inventors: Jun LUO, Tokyo (JP); Takefumi Nagumo, Kanagawa (JP)

(21) Appl. No.: 13/429,894

(22) Filed: Mar. 26, 2012

(30) Foreign Application Priority Data
Apr. 19, 2011 (JP) 2011-092576

(51) Int. Cl. G06K 9/36

(52) U.S. Cl. 382/236

(57) ABSTRACT

There is provided an apparatus including: a low-bit criterion image generation unit that reduces a bit number assigned to a pixel in a criterion image and generates low-bit criterion image data; a low bit reference image generation unit that reduces a bit number of a reference mage and generates low-bit reference image data; and a motion vector information generation unit that detects a block-unit local motion vector from the low-bit criterion/reference images and calculates reliability of the detected local motion vector. By reducing the image bit number, it is possible to detect a local motion vector in a simple configuration. By calculating a global motion vector using a local motion vector according to reliability, even if a local motion vector is detected from an image of the reduced bit number, it is possible to calculate a global motion vector at higher accuracy.

### BACKGROUND

The present technology relates to an information processing apparatus, information processing method and program. Specifically, the present technology enables a global motion vector calculation at higher accuracy with a simple configuration.

In the past, the motion vectors of the objects in images of different times are detected, and, based on the detected motion vectors, for example, motion-compensated interframe coding in efficient coding of the image or noise reduction by an interframe time domain filter is performed.

As a method of detecting such motion vectors, for example, a block matching method is used. In the block matching method, one screen is divided into blocks having several pixels. Next, between the blocked image data and a search area having blocked image data of a screen of different time to search an area in which that image data is moved, an evaluation value showing the similarity of images is calculated using a predetermined evaluation function. Further, a motion vector is detected based on the calculated evaluation value.

In this block matching method, the similarity is calculated between the search target block and each block in the search area, and therefore a calculation amount in motion vector detection becomes large. To cope with this, a technology of JP-A-07-222158 detects motion vectors in pixel units in a higher layer of low resolution and, based on the motion vectors detected in pixel units, detects motion vectors of precision less than a pixel unit in the higher layer. Further, based on the motion vectors of precision less than a pixel unit, by detecting motion vectors in a lower layer of higher resolution than that of the higher layer, the detection precision of motion vectors is improved and a calculation amount is reduced.

Further, in the motion vector detection, a local motion vector (“LMV”) which is a block-unit motion vector is detected. Further, from the detected local motion vector, a global motion vector (“GMV”) which is one motion vector corresponding to one frame is calculated. For example, a technology of JPA-2009-65332 calculates a global motion vector from a local motion vector and a block weight.

For example, JP-A-07-222158 (Patent Document 1) and JP-A-2009-65332 (Patent Document 2) are provided as reference for these technologies.

### SUMMARY

Meanwhile, when calculating an evaluation value such as a sum of absolute difference (“SAD”) using an image of low resolution and detecting a motion vector from a block position in which the sum of absolute difference is minimum, the number of blocks decreases because of low resolution. However, even if an image of low resolution is used, in a case where the block sizes are equal, it is difficult to decrease the memory capacity to store an image for local motion vector detection. Further, it is difficult to decrease the circuit size of a logic circuit to calculate an evaluation value. Further, when calculating a global motion vector from a detected local motion vector, since it is difficult to decrease the memory capacity and circuit size used to detect the local motion vector, it is difficult to calculate the global motion vector in a simple configuration.

In light of the foregoing, it is desirable in the present technology to provide an information processing apparatus, information processing method and program to enable a global motion vector to be calculated at high precision in a simple configuration.

According to a first embodiment of the present disclosure, there is provided an information processing apparatus which includes: a low-bit image generation unit configured to reduce a bit number assigned to a pixel in a criterion image and a reference image and generate a low-bit criterion image and a low-bit reference image; and a motion vector information generation unit configured to detect a local motion vector, which is a motion vector for each of blocks constituting an image, from the low-bit criterion image and the low-bit reference image, and calculate a reliability of the detected local motion vector.

In this disclosure, the low-bit image generation unit reduces a bit number assigned to a pixel in a criterion image and a reference image and generates a low-bit criterion image and a low-bit reference image. For example, by block matching, the motion vector information generation unit detects a local motion vector, which is a motion vector for each of blocks constituting an image, from the low-bit criterion image and the low-bit reference image. Further, the motion vector information generation unit calculates a reliability of the local motion vector using an evaluation value used to detect the local motion vector and/or the low-bit criterion image. When calculating the reliability using the evaluation value, the motion vector information generation unit calculates the reliability based on a difference between a first extreme value at which the evaluation value is the closest to a predetermined value and a second extreme value at which the evaluation value is the second closest to the predetermined value, using the evaluation value closer to the predetermined value in a higher similarity between blocks of the low-bit criterion image and the low-bit reference image. For example, using a sum of absolute difference as an evaluation value, the reliability is made higher in a larger difference between a first minimal value at which the sum of absolute difference is the smallest and a second minimal value at which the sum of absolute difference is the second smallest. Further, in the case of calculating the reliability using the low-bit criterion image, the motion vector information generation unit provides a higher reliability when variability in angle information related to a luminance gradient of a block image becomes less. Further, in the case of calculating reliability based on the evaluation value and reliability based on the low-bit criterion image, for example, when the reliabilities are binary information, the motion vector information generation unit performs a logical operation of the two reliabilities to integrate the reliabilities, and, when the reliabilities are multivalued information, the motion vector information generation unit multiplies the two reliabilities to integrate the reliabilities. Further, a global motion vector calculation unit is provided to calculate a global motion vector, which is one image-unit motion vector between the criterion image and the reference image, from the detected local motion vector and the calculated reliability.

According to a second embodiment of the present disclosure, there is provided an information processing method which includes: reducing a bit number assigned to a pixel in a criterion image and a reference image and generating a low-bit criterion image and a low-bit reference image; and detecting a local motion vector, which is a motion vector for each of blocks constituting an image, from the low-bit criterion image and the low-bit reference image, and calculating a reliability of the detected local motion vector.

According to a third embodiment of the present disclosure, there is provided a program which causes a computer to execute: reducing a bit number assigned to a pixel in a criterion image and a reference image and generating a low-bit criterion image and a low-bit reference image; and detecting a local motion vector, which is a motion vector for each of blocks constituting an image, from the low-bit criterion image and the low-bit reference image, and calculating a reliability of the detected local motion vector.

Here, a computer program of the present technology denotes, for example, a computer program that can be provided by a storage medium such as an optical disk, magnetic disk and semiconductor memory, or by a communication medium such as a network, to a general-purpose computer system that can execute various program codes, where these media are provided in a computer-readable manner. By providing such a program in a computer-readable manner, processing corresponding to the program is realized on the computer system.

According to the present technology, from a low-bit criterion image and low-bit reference image generated by reducing a bit number assigned to a pixel in a criterion image and reference image, a local motion vector, which is a motion vector for each of blocks constituting an image, is detected. Further, the reliability of the detected local motion vector is calculated. Therefore, it is possible to detect the local motion vector in a simple configuration. Further, since the reliability of the local motion vector is calculated, based on the local motion vector and the reliability, it is possible to detect a global motion vector at higher accuracy.

### BRIEF DESCRIPTION OF THE DRAWINGS

FIG. 1 illustrates a configuration of an information processing apparatus according to a first embodiment;

FIG. 2 illustrates a flowchart illustrating processing according to an information processing apparatus according to the first embodiment;

FIG. 3 illustrates a configuration of a low-bit reference image generation unit in a case where a one-bit image is generated;

FIG. 4 is a flowchart illustrating processing in a low-bit reference image generation unit in a case where a one-bit image is generated;

FIG. 5 illustrates a configuration of a low-bit reference image generation unit in a case where a two-bit image is generated;

FIG. 6 illustrates a flowchart illustrating processing in a low-bit reference image generation unit in a case where a two-bit image is generated;

FIG. 7 illustrates a configuration of a low-bit reference image generation unit in a case where an n-bit image is generated;

FIG. 8 is a flowchart illustrating processing in a low-bit reference image generation unit in a case where an n-bit image is generated;

FIG. 9 exemplarily illustrates relationships between comparison results and pixel values;

FIG. 10 illustrates a configuration of a block matching unit;

FIG. 11 is a flowchart illustrating processing in a block matching unit;

FIG. 12 is a flowchart illustrating XOR value calculation processing;

FIG. 13 exemplarily illustrates a one-dimensional evaluation value table;

FIG. 14 exemplarily illustrates a configuration of a first reliability calculation unit;

FIG. 15 is a flowchart illustrating processing in the first reliability calculation unit;

FIG. 16 exemplarily illustrates a configuration of a second reliability calculation unit;

FIG. 17 is a flowchart illustrating processing in the second reliability calculation unit;

FIGS. 18A and 18B illustrate a configuration of a reliability integration unit;

FIG. 19 is a flowchart illustrating processing performed in the reliability integration unit;

FIG. 20 exemplarily illustrates a configuration of a block weight calculation unit;

FIG. 21 illustrates a configuration of an information processing apparatus according to a second embodiment;

FIG. 22 illustrates a configuration of an information processing apparatus according to a third embodiment; and

FIG. 23 illustrates a configuration example of computer hardware.

### DETAILED DESCRIPTION OF THE EMBODIMENTS

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Modes for implementing the technology will be described in the following order.

1. First embodiment
1-1. Configuration of information processing apparatus
1-2. Processing operation of information processing apparatus
1-3. Configuration and operation of low-bit image generation unit
1-4. Configuration and operation of block matching unit
1-5. Configuration and operation of first reliability calculation unit
1-6. Configuration and operation of second reliability calculation unit
1-7. Configuration and operation of reliability integration unit
1-8. Configuration and operation of global motion vector calculation unit
1-9. Configuration and operation of motion compensation unit

2. Second embodiment

3. Third embodiment

4. Case of performing processing by program

### 1. First Embodiment

An information processing apparatus of the present disclosure performs bit number reduction processing of reducing the number of bits assigned to pixels, on a criterion image and a reference image, and generates a low-bit criterion image and reference image of reduced bits. Next, the information processing apparatus detects a local motion vector by block matching using the low-bit criterion image and reference image, and calculates the reliability based on the low-bit criterion image and a block matching result. Further, the information processing apparatus detects a global motion vector from the local motion vectors and reliabilities, and performs motion compensation of the reference image based on the detected global motion vector. The local motion vector (“LMV”) denotes a block-unit motion vector and the global motion vector (“GMV”) denotes one motion vector corresponding to one frame. Also, in the following explanation, a configuration and operation of an information processing apparatus according to the first embodiment will be described, and then each unit configuring the information processing apparatus will be described in detail.

### [1-1. Configuration of Information Processing Apparatus]

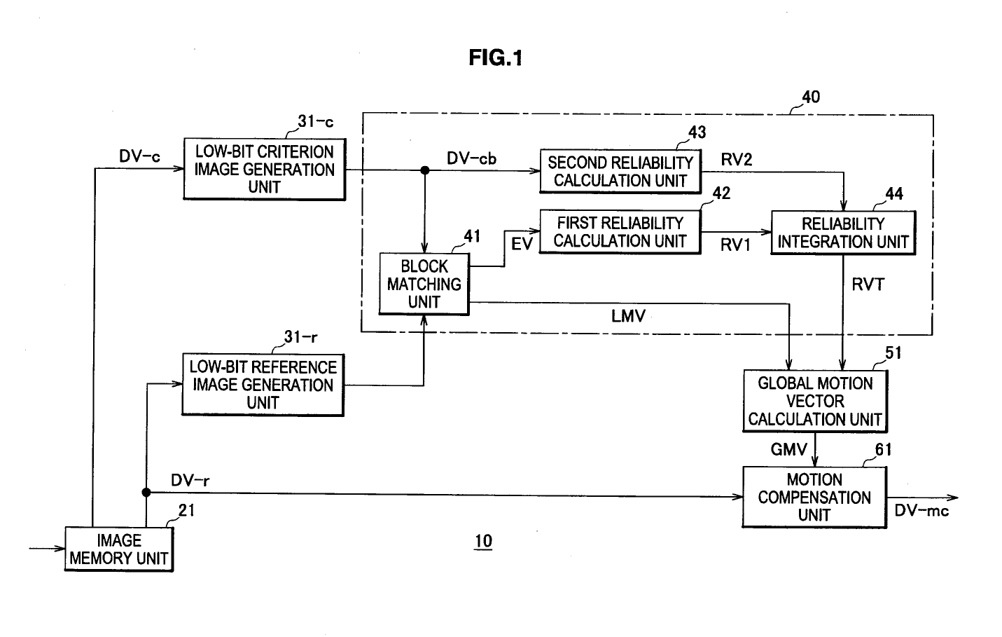

FIG. 1 illustrates a configuration of the information processing apparatus according to the first embodiment. An information processing apparatus 10 has an image memory unit 21 that stores input image data. Further, the information processing apparatus 10 has a low-bit criterion image generation unit 31-c and low-bit reference image generation unit 31-r that reduce the number of bits assigned to pixels. Further, the information processing apparatus 10 has a motion vector information generation unit 40 that detects a local motion vector and calculates the reliability of the detected local motion vector. Further, the information processing apparatus 10 has a global motion vector calculation unit 51 that calculates a global motion vector using the detected local motion vector and the calculated reliability. Also, the information processing apparatus 10 has a motion compensation unit 61 that performs motion compensation using the calculated global motion vector.

The image memory unit 21 stores image data of a criterion image and reference image. The image memory unit 21 outputs the stored criterion image data DV-c to the low-bit criterion image generation unit 31-c. The image memory unit 21 outputs the stored reference image data DV-r to the low-bit reference image generation unit 31-r and the motion compensation unit 61.

The low-bit criterion image generation unit 31-c performs bit number reduction processing on the criterion image data DV-c and generates low-bit criterion image data DV-cb. Further, the low-bit criterion image generation unit 31-c outputs the generated low-bit criterion image data DV-cb to a block matching unit 41 of the motion vector information generation unit 40. For example, the low-bit criterion image generation unit 31-c performs bit number reduction processing on eight-bit image data of the criterion image, and generates and outputs the low-bit criterion image data DV-cb of one bit to the block matching unit 41.

The low-bit reference image generation unit 31-r performs bit number reduction processing on the reference image data DV-r and generates low-bit reference image data DV-rb having the same bit number as that of the low-bit criterion image. Further, the low-bit reference image generation unit 31-r outputs the generated low-bit reference image data DV-rb to the block matching unit 41 of the motion vector information generation unit 40. For example, the low-bit reference image generation unit 31-r performs bit number reduction processing on eight-bit image data of the reference image, and generates and outputs the low-bit reference image data DV-rb of one bit to the block matching unit 41.

The motion vector information generation unit 40 has the block matching unit 41, a first reliability calculation unit 42, a second reliability calculation unit 43 and a reliability integration unit 44.

The block matching unit 41 performs block matching using the low-bit criterion image data DV-cb outputted from the low-bit criterion image generation unit 31-c and the low-bit reference image data DV-rb outputted from the low-bit reference image generation unit 31-r. The block matching unit 41 performs matching in block units and detects a local motion vector LMV. The block matching unit 41 outputs the detected local motion vector LMV to the global motion vector calculation unit 51. Further, the block matching unit 41 outputs an evaluation value EV calculated to detect the local motion vector LMV, to the first reliability calculation unit 42.

The first reliability calculation unit 42 calculates reliability RV1 of the local motion vector LMV detected in the block matching unit 41, using the evaluation value EV supplied from the block matching unit 41. The first reliability calculation unit 42 outputs the calculated reliability RV1 to the reliability integration unit 44.

The second reliability calculation unit 43 calculates the reliability of the local motion vector LMV detected in the block matching unit 41, using the low-bit criterion image data DV-cb. The second reliability calculation unit 43 calculates block-unit feature amounts using the low-bit image and calculates reliability RV2 from the feature amounts. The second reliability calculation unit 43 outputs the calculated reliability RV2 to the reliability integration unit 44.

The reliability integration unit 44 integrates the reliability RV1 calculated in the first reliability calculation unit 42 and the reliability RV2 calculated in the second reliability calculation unit 43, and provides integrated reliability RVT as reliability of the local motion vector LMV calculated in the block matching unit 41. The reliability integration unit 44 outputs the integrated reliability RVT to the global motion vector calculation unit 51.

The global motion vector calculation unit 51 calculates a global motion vector GMV using the local motion vector LMV and the reliability RVT supplied from the motion vector information generation unit 40, and outputs the global motion vector GMV to the motion compensation unit 61.

The information processing apparatus 10 includes the motion compensation unit 61, and the motion compensation unit 61 performs motion compensation of the reference image depending on the global motion vector GMV calculated in the global motion vector calculation unit 51, and outputs motion compensation image data DV-mc.

### [1-2. Processing Operation of Information Processing Apparatus]

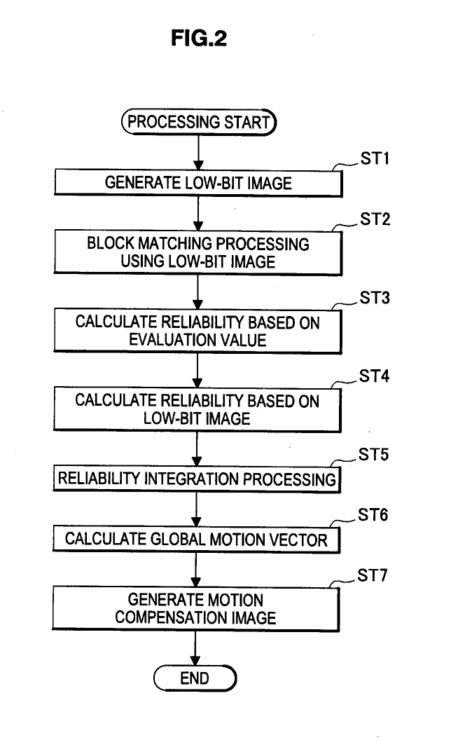

FIG. 2 is a flowchart illustrating processing in the information processing apparatus according to the first embodiment. In step ST1, the low-bit criterion image generation unit 31-c and the low-bit reference image generation unit 31-r generate low-bit images. The low-bit criterion image generation unit 31-c performs bit number reduction processing on the criterion image data DV-c and generates the low-bit criterion image data DV-cb. The low-bit reference image generation unit 31-r performs bit number reduction processing on the reference image data DV-r and generates the low-bit reference image data DV-rb. Thus, the low-bit criterion image generation unit 31-c and the low-bit reference image generation unit 31-r generate the low-bit images, and the flow proceeds to step ST2.

In step ST2, the block matching unit 41 performs block matching processing using the low-bit images. The block matching unit 41 performs block matching processing using the low-bit criterion image data DV-cb and the low-bit reference image data DV-rb in block units and detects the local motion vector LMV, and the flow proceeds to step ST3.

In step ST3, the first reliability calculation unit 42 calculates the reliability RV1 based on an evaluation value. The first reliability calculation unit 42 calculates the reliability RV1 of the local motion vector LMV using the evaluation value EV calculated in the block matching processing, and the flow proceeds to step ST4.

In step ST4, the second reliability calculation unit 43 calculates reliability based on the low-bit image. The second reliability calculation unit 43 calculates the reliability RV2 of the local motion vector LMV from the block-unit feature amounts calculated using the low-bit image, and the flow proceeds to step ST5. Here, the processing in step ST3 and the processing in step ST4 may be performed in parallel, or the processing in step ST4 may be performed first.

In step ST5, the reliability integration unit 44 performs reliability integration processing. The reliability integration unit 44 integrates the reliability RV1 calculated in step ST3 and the reliability RV2 calculated in step ST4 to generate the integrated reliability RVT, and the flow proceeds to step ST6.

In step ST6, the global motion vector calculation unit 51 calculates the global motion vector GMV. The global motion vector calculation unit 51 calculates the global motion vector GMV using the local motion vector LMV calculated in step ST2 and the integrated reliability RVT obtained in step ST5, and the flow proceeds to step ST7.

In step ST7, the motion compensation unit 61 generates a motion compensation image. The motion compensation unit 61 performs motion compensation of the reference image depending on the global motion vector GMV calculated in step ST6 and generates the motion compensation image data DV-mc, and the processing is terminated.

Also, the information processing apparatus may perform processing until step ST5 and other devices may calculate the global motion vector and perform motion compensation of the reference image. Also, the information processing apparatus may perform processing until step ST6 and other devices may perform motion compensation of the reference image.

### [1-3. Configuration and Operation of Low-Bit Image Generation Unit]

Next, generation of a low-bit image will be explained. The low-bit criterion image generation unit 31-c performs filter processing of the criterion image, compares image data before and after the filter processing for each pixel, and generates the criterion image data DV-cb reducing bits from the comparison results. At the same time, the low-bit reference image generation unit 31-r performs filter processing on the reference image, compares image data before and after the filter processing for each pixel, and generates the reference image data DV-rb reducing bits from the comparison results.

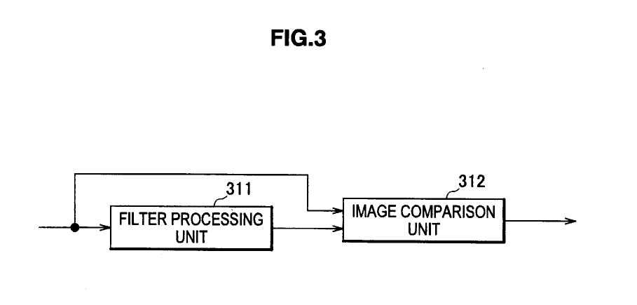

FIG. 3 illustrates a configuration of the low-bit criterion image generation unit 31-c in a case where a one-bit image is generated. Here, as well as the low-bit criterion image generation unit 31-c, the low-bit reference image generation unit 31-r is provided and performs the same processing on the reference image as in the low-bit criterion image generation unit 31-c.

The low-bit criterion image generation unit 31-c has a filter processing unit 311 and an image comparison unit 312. The filter processing unit 311 performs filter processing on the criterion image data DV-c. Specifically, the filter processing unit 311 performs filter processing on the criterion image data DV-c using, for example, a mean filter, a band-pass filter or a pseudo mean filter.

When using the mean filter, the filter processing unit 311 performs a computation of Equation 1 and calculates pixel data I′(x, y) after filter processing in pixel position (x, y). Here, I(i, j) represents pixel data of the criterion image and N represents a pixel number.

$$\begin{matrix}[ Expression 1 ] & \\ {I}^{′} ( x , y ) = \frac{1}{{N}^{2}} {\sum }_{i = x - \frac{N}{2}}^{x + \frac{N}{2}} {\sum }_{j = y - \frac{N}{2}}^{y + \frac{N}{2}} I ( i , j ) & ( 1 )\end{matrix}$$

When using the band-pass filter, the filter processing unit 311 performs a computation of Equation 2 and calculates pixel data I′(x, y) after filter processing in pixel position (x, y). Here, in Equation 2, “K” represents a coefficient to determine a filter characteristic and has a value shown in Equation 3, for example.

$$\begin{matrix}[ Expression 2 ] & \\ {I}^{′} ( x , y ) = {\sum }_{i = x - \frac{N}{2}}^{x - \frac{N}{2}} {\sum }_{j = y - \frac{N}{2}}^{y + \frac{N}{2}} ( I ( i , j ) \times K ( i + \frac{N}{2} , j + \frac{N}{2} ) ) & ( 2 ) \\ [ Expression 3 ] & \\ K = \frac{1}{16} [ \begin{matrix}0 & 0 & 0 & 0 & 0 & 0 & 0 & 0 & 0 & 1 & 0 & 0 & 0 & 0 & 0 & 0 & 0 & 0 & 0 \\ 0 & 0 & 0 & 0 & 0 & 0 & 0 & 0 & 0 & 0 & 0 & 0 & 0 & 0 & 0 & 0 & 0 & 0 & 0 \\ 0 & 0 & 0 & 0 & 0 & 0 & 0 & 0 & 0 & 0 & 0 & 0 & 0 & 0 & 0 & 0 & 0 & 0 & 0 \\ 0 & 0 & 0 & 0 & 0 & 0 & 1 & 0 & 0 & 0 & 0 & 0 & 1 & 0 & 0 & 0 & 0 & 0 & 0 \\ 0 & 0 & 0 & 0 & 0 & 0 & 0 & 0 & 0 & 0 & 0 & 0 & 0 & 0 & 0 & 0 & 0 & 0 & 0 \\ 0 & 0 & 0 & 0 & 0 & 0 & 0 & 0 & 0 & 0 & 0 & 0 & 0 & 0 & 0 & 0 & 0 & 0 & 0 \\ 0 & 0 & 0 & 1 & 0 & 0 & 0 & 0 & 0 & 1 & 0 & 0 & 0 & 0 & 0 & 1 & 0 & 0 & 0 \\ 0 & 0 & 0 & 0 & 0 & 0 & 0 & 0 & 0 & 0 & 0 & 0 & 0 & 0 & 0 & 0 & 0 & 0 & 0 \\ 0 & 0 & 0 & 0 & 0 & 0 & 0 & 0 & 0 & 0 & 0 & 0 & 0 & 0 & 0 & 0 & 0 & 0 & 0 \\ 1 & 0 & 0 & 0 & 0 & 0 & 1 & 0 & 0 & 0 & 0 & 0 & 1 & 0 & 0 & 0 & 0 & 0 & 1 \\ 0 & 0 & 0 & 0 & 0 & 0 & 0 & 0 & 0 & 0 & 0 & 0 & 0 & 0 & 0 & 0 & 0 & 0 & 0 \\ 0 & 0 & 0 & 0 & 0 & 0 & 0 & 0 & 0 & 0 & 0 & 0 & 0 & 0 & 0 & 0 & 0 & 0 & 0 \\ 0 & 0 & 0 & 1 & 0 & 0 & 0 & 0 & 0 & 1 & 0 & 0 & 0 & 0 & 0 & 1 & 0 & 0 & 0 \\ 0 & 0 & 0 & 0 & 0 & 0 & 0 & 0 & 0 & 0 & 0 & 0 & 0 & 0 & 0 & 0 & 0 & 0 & 0 \\ 0 & 0 & 0 & 0 & 0 & 0 & 0 & 0 & 0 & 0 & 0 & 0 & 0 & 0 & 0 & 0 & 0 & 0 & 0 \\ 0 & 0 & 0 & 0 & 0 & 0 & 1 & 0 & 0 & 0 & 0 & 0 & 1 & 0 & 0 & 0 & 0 & 0 & 0 \\ 0 & 0 & 0 & 0 & 0 & 0 & 0 & 0 & 0 & 0 & 0 & 0 & 0 & 0 & 0 & 0 & 0 & 0 & 0 \\ 0 & 0 & 0 & 0 & 0 & 0 & 0 & 0 & 0 & 0 & 0 & 0 & 0 & 0 & 0 & 0 & 0 & 0 & 0 \\ 0 & 0 & 0 & 0 & 0 & 0 & 0 & 0 & 0 & 1 & 0 & 0 & 0 & 0 & 0 & 0 & 0 & 0 & 0\end{matrix} ] & ( 3 )\end{matrix}$$

When using the pseudo mean filter, the filter processing unit 311 performs a computation of Equation 4 and calculates pixel data I′(x, y) after filter processing in pixel position (x, y).

$$\begin{matrix}[ Expression 4 ] & \\ {I}^{′} ( x , y ) = \frac{1}{2} ( {max}_{( i , j ) ∈ ( N \times N )} ( I ( i , j ) ) + {min}_{( i , j ) ∈ ( N \times N )} ( I ( i , j ) ) ) & ( 4 )\end{matrix}$$

The image comparison unit 312 compares the criterion image data and the image data subjected to filter processing, and provides a one-bit signal representing the comparison result, as the low-bit criterion image.

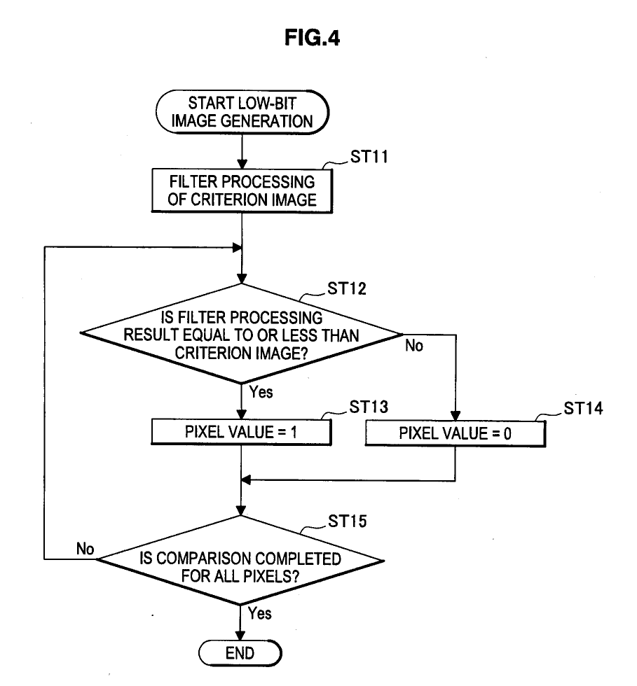

FIG. 4 is a flowchart illustrating processing in the low-bit criterion image generation unit 31-c in a case where a one-bit image is generated. In step ST11, the low-bit criterion image generation unit 31-c performs filter processing on the criterion image. The low-bit criterion image generation unit 31-c performs filter processing on the criterion image data DV-c using the mean filter, the band-pass filter or the like, and the flow proceeds to step ST12.

In step ST12, the low-bit criterion image generation unit 31-c decides whether a filter processing result is equal to or less than the criterion image. The low-bit criterion image generation unit 31-c compares pixel data in each image position between the image data subjected to filter processing and the criterion image data. If the low-bit criterion image generation unit 31-c finds that pixel data of the filter processing result is equal to or less than pixel data of the criterion image, the flow proceeds to step ST13. By contrast, if the low-bit criterion image generation unit 31-c finds that the pixel data of the filter processing result is greater than the pixel data of the criterion image, the flow proceeds to step ST14. In step ST13, the low-bit criterion image generation unit 31-c sets a pixel value to “1” and the flow proceeds to step ST15.

In step ST14, the low-bit criterion image generation unit 31-c sets a pixel value to “0” and the flow proceeds to step ST15.

In step ST15, the low-bit criterion image generation unit 31-c decides whether comparison for all pixels is completed. If comparison for all pixels is not completed, the flow proceeds back to step ST12 and the low-bit criterion image generation unit 31-c performs a comparison for the next pixel. By contrast, if comparison for all pixels is completed, the low-bit criterion image generation unit 31-c terminates processing.

Thus, by comparing image data before and after filter processing for each pixel, it is possible to generate an image of one bit assigned to pixels from the comparison results.

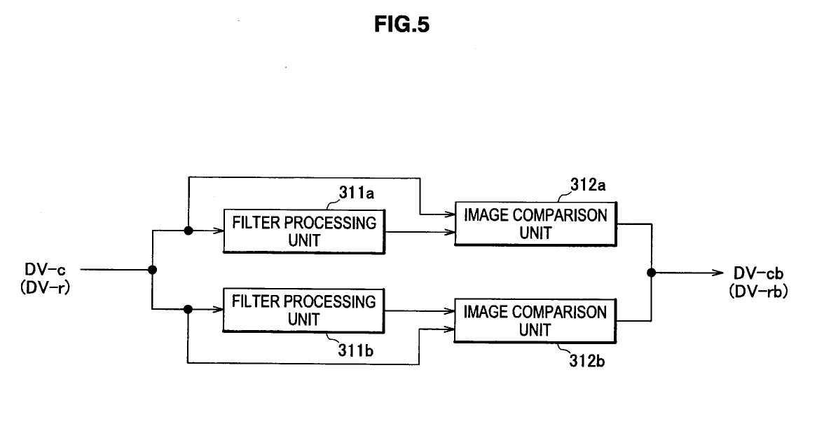

Next, a case will be explained where the low-bit criterion image generation unit 31-c generates a two-bit image or n-bit image. FIG. 5 illustrates a configuration of the low-bit criterion image generation unit 31-c in a case where a two-bit image is generated.

The low-bit criterion image generation unit 31-c has filter processing units 311a and 311b and image comparison units 312a and 312b. The filter processing unit 311a performs filter processing of the criterion image data. As described above, the filter processing unit 311a performs filter processing of the criterion image data using the mean filter, the band-pass filter, the pseudo mean filter or the like. The image comparison unit 312a compares the criterion image data and the image data subjected to filter processing, and provides a one-bit signal representing the comparison result, as the least significant bit data of two-bit image. The filter processing unit 311b performs filter processing of the criterion image data by a different filter characteristic from that of the filter processing unit 311a. Similar to the filter processing unit 311a, the filter processing unit 311b performs filter processing of the criterion image data using the mean filter, the band-pass filter, the pseudo mean filter or the like. The image comparison unit 312b compares the criterion image data and the image data subjected to filter processing, and provides a one-bit signal representing the comparison result, as the most significant bit data of two-bit image.

Thus, by comparing image data before and after filter processing for each pixel, it is possible to generate image data DV of two bits assigned to pixels from the comparison results.

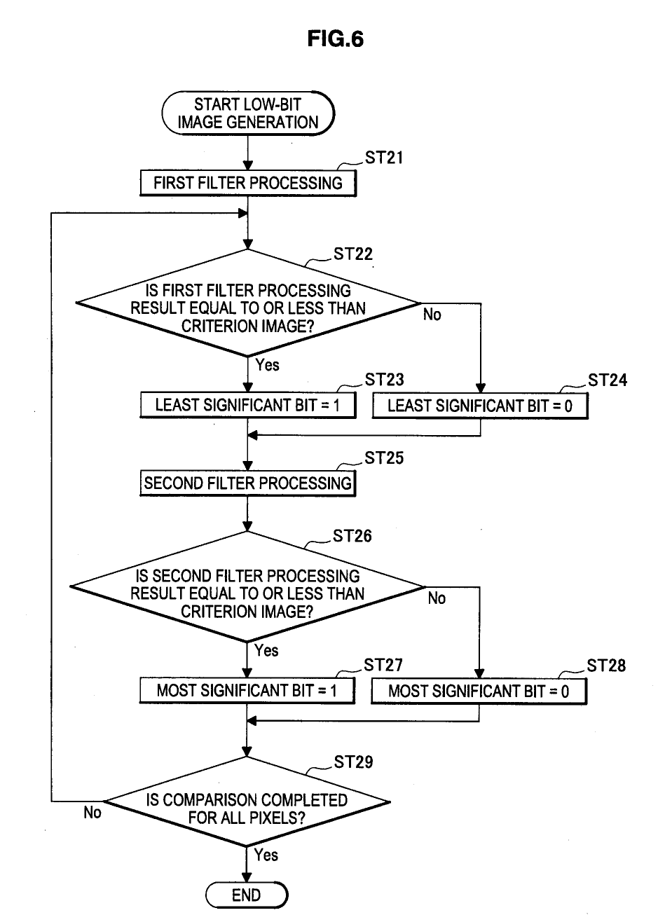

FIG. 6 is a flowchart illustrating processing in the low-bit criterion image generation unit 31-c in a case where a two-bit image is generated. In step ST21, the low-bit criterion image generation unit 31-c performs first filter processing of the criterion image. The low-bit criterion image generation unit 31-c performs the first filter processing on the criterion image data using the mean filter, the band-pass filter or the like, and the flow proceeds to step ST22.

In step ST22, the low-bit criterion image generation unit 31-c decides whether the first filter processing result is equal to or less than the criterion image. The low-bit criterion image generation unit 31-c compares pixel data for each image position using the image data subjected to filter processing and the criterion image data. If the low-bit criterion image generation unit 31-c finds that pixel data of the filter processing result is equal to or less than pixel data of the criterion image data, the flow proceeds to step ST23. By contrast, the low-bit criterion image generation unit 31-c finds that the pixel data of the filter processing result is greater than the pixel data of the criterion image, the flow proceeds to step ST24.

In step ST23, the low-bit criterion image generation unit 31-c sets a pixel value to “1” and provides it as the least significant bit data of two-bit image, and the flow proceeds to step ST25.

In step ST24, the low-bit criterion image generation unit 31-c sets a pixel value to “0” and provides it as the least significant bit data of two-bit image, and the flow proceeds to step ST25.

In step ST25, the low-bit criterion image generation unit 31-c performs second filter processing of the criterion image. The low-bit criterion image generation unit 31-c performs the second filter processing on the criterion image data by a different characteristic from in step ST21, using the mean filter, the band-pass filter or the like, and the flow proceeds to step ST26.

In step ST26, the low-bit criterion image generation unit 31-c decides whether the second filter processing result is equal to or less than the criterion image. The low-bit criterion image generation unit 31-c compares pixel data for each image position using the image data subjected to filter processing and the criterion image data. If the low-bit criterion image generation unit 31-c finds that pixel data of the filter processing result is equal to or less than pixel data of the criterion image, the flow proceeds to step ST27. By contrast, if the low-bit criterion image generation unit 31-c finds that the pixel data of the filter processing result is greater than the pixel data of the criterion image, the flow proceeds to step ST28.

In step ST27, the low-bit criterion image generation unit 31-c sets a pixel value to “1” and provides it as the most significant bit data of two-bit image, and the flow proceeds to step ST29.

In step ST28, the low-bit criterion image generation unit 31-c sets a pixel value to “0” and provides it as the most significant bit data of two-bit image, and the flow proceeds to step ST29.

In step ST29, the low-bit criterion image generation unit 31-c decides whether comparison for all pixels is completed. If comparison for all pixels is not completed, the flow proceeds back to step ST22 and the low-bit criterion image generation unit 31-c performs a comparison for the next pixel. By contrast, if comparison for all pixels is completed, the low-bit criterion image generation unit 31-c terminates processing.

Thus, by comparing image data before and after filter processing for each pixel, it is possible to generate an image of two bits assigned to pixels from the comparison results.

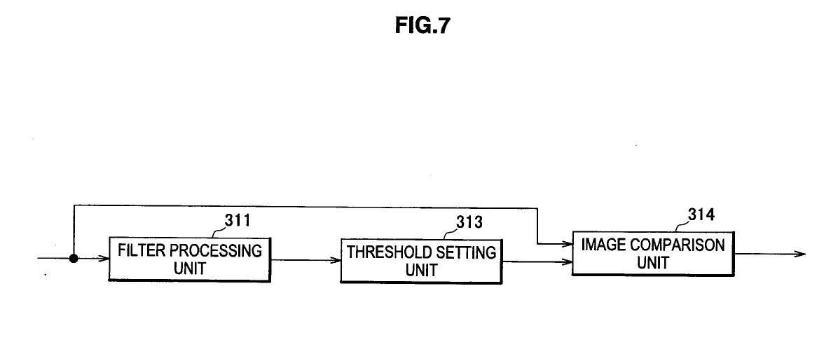

Next, a case will be explained where an n-bit image is generated. FIG. 7 illustrates a configuration of the low-bit criterion image generation unit 31-c in a case where an n-bit image is generated.

The low-bit criterion image generation unit 31-c has the filter processing unit 311, a threshold setting unit 313 and an image comparison unit 314. The filter processing unit 311 performs filter processing of the criterion image data DV-c. As described above, the filter processing unit 311 performs filter processing of the criterion image using the mean filter, the band-pass filter, the pseudo mean filter or the like.

The threshold setting unit 313 performs shift processing of image data subjected to filter processing, and sets the image data subjected to filter processing and the image data subjected to shift processing as thresholds. Further, the threshold setting unit 313 outputs the set threshold to the image comparison unit 314.

The image comparison unit 314 compares the criterion image data and the threshold output from the threshold setting unit 313 for each pixel, and provides an n-bit signal representing the comparison results, as the low-bit criterion image data DV-cb.

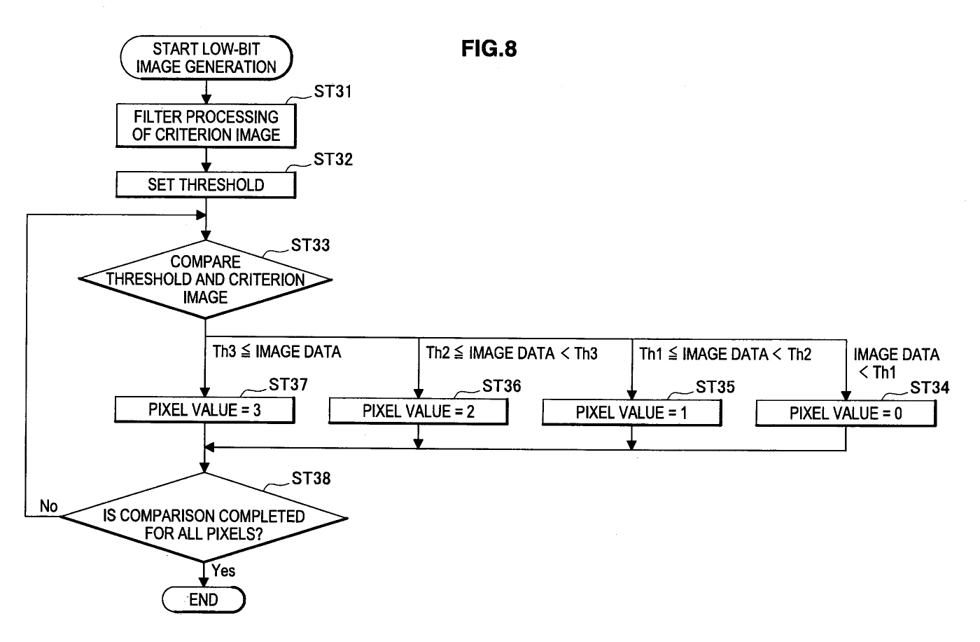

FIG. 8 is a flowchart illustrating processing in the low-bit criterion image generation unit 31-c in a case where an n-bit image is generated. In step ST31, the low-bit criterion image generation unit 31-c performs filter processing of the criterion image. Specifically, the low-bit criterion image generation unit 31-c performs filter processing on the criterion image data using the mean filter, the band-pass filter or the like, and the flow proceeds to step ST32.

In step ST32, the low-bit criterion image generation unit 31-c performs threshold setting. The low-bit criterion image generation unit 31-c performs shift processing of the image data subjected to filter processing and sets the image data subjected to filter processing and the image data subjected to shift processing as thresholds, and the flow proceeds to step ST33. For example, in a case where a two-bit image is generated, the low-bit criterion image generation unit 31-c provides image data obtained by decreasing the image data subjected to filter processing by a preset shift amount, as a first threshold. Further, the low-bit criterion image generation unit 31-c provides the image data subjected to filter processing as a second threshold and provides image data obtained by increasing the image data subjected to filter processing by a preset shift amount, as a third threshold. Further, in a case where an n-bit image is generated, the low-bit criterion image generation unit 31-c sets (2n−1) thresholds based on the image data subjected to filter processing.

In step ST33, the low-bit criterion image generation unit 31-c compares the criterion image data and the thresholds for each pixel. If the low-bit criterion image generation unit 31-c finds that the criterion image data is less than the first threshold Th1, the flow proceeds to step ST34. If the low-bit criterion image generation unit 31-c finds that the criterion image data is equal to or greater than the first threshold Th1 but less than the second threshold Th2, the flow proceeds to step ST35. If the low-bit criterion image generation unit 31-c finds that the criterion image data is equal to or greater than the second threshold Th2 but less than the third threshold Th3, the flow proceeds to step ST36. If the low-bit criterion image generation unit 31-c finds that the criterion image data is equal to or greater than the third threshold Th3, the flow proceeds to step ST37.

In step ST34, the low-bit criterion image generation unit 31-sets a pixel value to “0” and the flow proceeds to step ST38.

In step ST35, the low-bit criterion image generation unit 31-sets a pixel value to “1” and the flow proceeds to step ST38.

In step ST36, the low-bit criterion image generation unit 31-sets a pixel value to “2” and the flow proceeds to step ST38.

In step ST37, the low-bit criterion image generation unit 31-c sets a pixel value to “3” and the flow proceeds to step ST38.

In step ST38, the low-bit criterion image generation unit 31-c decides whether comparison for all pixels is completed. If comparison for all pixels is not completed, the flow proceeds back to step ST32 and the low-bit criterion image generation unit 31-c performs a comparison for the next pixel. Also, if comparison for all pixels is completed, the low-bit criterion image generation unit 31-c terminates processing.

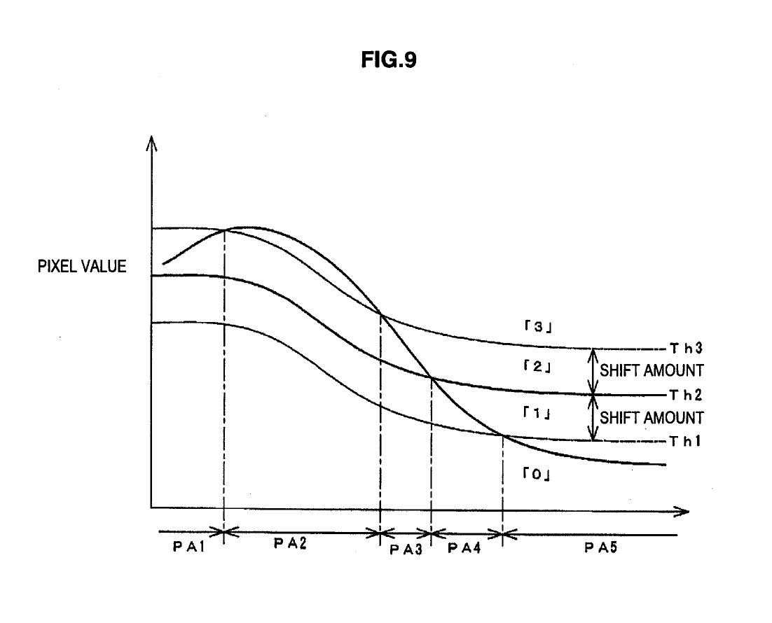

FIG. 9 exemplarily illustrates relationships between comparison results and pixel values. When the pixel position is in area PA1, the pixel value of the criterion image is equal to or greater than the second threshold Th2 but less than the third threshold Th3. Therefore, the low-bit criterion image generation unit 31-c sets the pixel value in the area PA1 to “2.” When the pixel position is in area PA2, the pixel value of the criterion image is equal to or greater than the third threshold Th3. Therefore, the low-bit criterion image generation unit 31-c sets the pixel value in the area PA2 to “3.” When the pixel position is in area PA3, the pixel value of the criterion image is equal to or greater than the second threshold Th2 but less than the third threshold Th3. Therefore, the low-bit criterion image generation unit 31-c sets the pixel value in the area PA3 to “2.” When the pixel position is in area PA4, the pixel value of the criterion image is equal to or greater than the first threshold Th1 but less than the second threshold Th2. Therefore, the low-bit criterion image generation unit 31-c sets the pixel value in the area PA4 to “1.” When the pixel position is in area PA5, the pixel value of the criterion image is less than the first threshold Th1. Therefore, the low-bit criterion image generation unit 31-c sets the pixel value in the area PA5 to “0.”

Thus, instead of image data subjected to filter processing, by using thresholds set based on the image data subjected to filter processing and performing a pixel-level comparison of the thresholds with the pixel level before filter processing for each pixel, it is possible to generate an image of n bits assigned to pixels from the comparison results.

### [1-4. Configuration and Operation of Block Matching Unit]

Next, a block matching unit will be explained. The block matching unit calculates evaluation values between criterion image blocks and reference image blocks, and detects a local motion vector based on the evaluation values. That is, based on the evaluation values, the block matching unit detects a block position in which an image of a criterion image block image and an image of a reference image block image are the most similar, and calculates a local motion vector from the coordinate value of the detected block position.

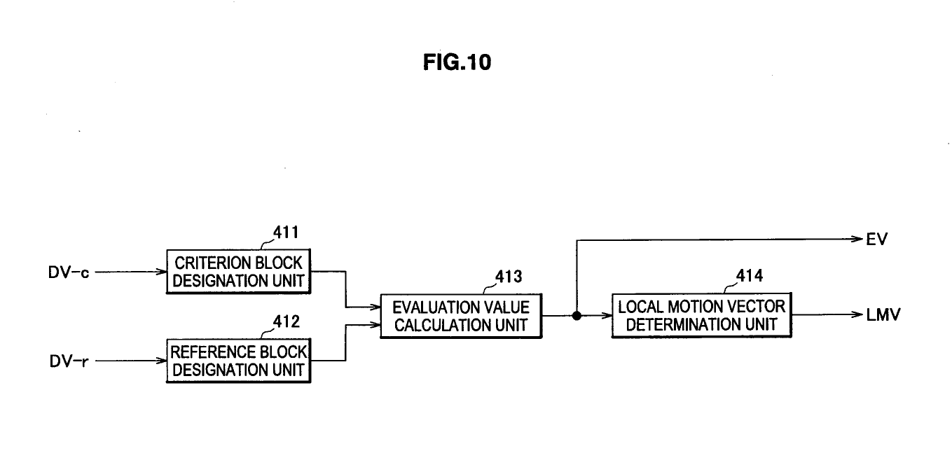

FIG. 10 illustrates a configuration of a block matching unit 41. The block matching unit 41 calculates a local motion vector using the low-bit criterion image data DV-cb and the low-bit reference image data DV-rb.

A criterion block designation unit 411 designates a block of the low-bit criterion image to detect a motion vector, and outputs image data in the designated block to an evaluation value calculation unit 413.

A reference block designation unit 412 designates a reference block range from a motion vector search range and outputs image data of the designated range to the evaluation value calculation unit 413.

The evaluation value calculation unit 413 calculates an evaluation value between the block designated in the criterion block designation unit 411 and a block in the search range designated in the reference block designation unit 412. This evaluation value calculation is performed in each position by sequentially moving a block in the search range within the search range. The evaluation value calculation unit 413 uses an evaluation value, which is closer to a predetermined value in higher similarity between blocks of the low-bit criterion image and low-bit reference image, as an evaluation value. For example, as an evaluation value, the sum of absolute difference (SAD) or the sum of XOR (SOX) is used. Also, for example, it may be possible to use the sum of squared difference (SSD) or the normalized cross correlation (“NCC”) as an evaluation.

When using the sum of absolute difference SAD, the evaluation calculation unit 413 performs a computation of Equation 5. Here, in Equation 5, T(i, j) represents pixel data in position (i, j) in a low-bit criterion image block, and S(i, j) represents pixel data in position (i, j) in a low-bit reference image block.

$$\begin{matrix}[ Expression 5 ] & \\ SAD = {\sum }_{i} {\sum }_{j} \vert T ( i , j ) - S ( i , j ) \vert & ( 5 )\end{matrix}$$

When using the sum of XOR SOX as an evaluation value, the evaluation calculation unit 413 performs a computation of Equations 6 and 7. Here, in Equation 7 to calculate the XOR value, T(i, j) represents pixel data in position (i, j) in a low-bit criterion image block, and S(i, j) represents pixel data in position (i, j) in a low-bit reference image block.

$$\begin{matrix}[ Expression 6 ] & \\ SOX = {\sum }_{i} {\sum }_{j} XOR ( i , j ) & ( 6 ) \\ XOR = T ( i , j ) ⊗ S ( i , j ) & ( 7 )\end{matrix}$$

Also, when using the sum of XOR SOX as an evaluation value, the evaluation value calculation unit 413 performs a computation of Equation 8 as the calculation of the XOR value of n bits if the low-bit criterion image data and the low-bit reference image data are n bits. That is, by the computation of Equation 8, “XOR=0” is provided if these items of pixel data are equal, and “XOR=1” is provided if these items of pixel data are not equal. Here, in Equation 8, “k” represents the k-th order of a bit number assigned to a pixel.

$$\begin{matrix}[ Expression 7 ] & \\ XOR = T ( i , j ) ⊗ S ( i , j ) = {{⋃}_{k = 1}}^{n} ( {T}_{k} ( i , j ) ⊗ {S}_{k} ( i , j ) ) & ( 8 )\end{matrix}$$

A local motion vector determination unit 414 detects a position of a reference image block having the highest similarity to the criterion image block based on the evaluation value. Further, a local motion vector LMV is found from a coordinate difference between the criterion image block and the reference image block having the highest similarity.

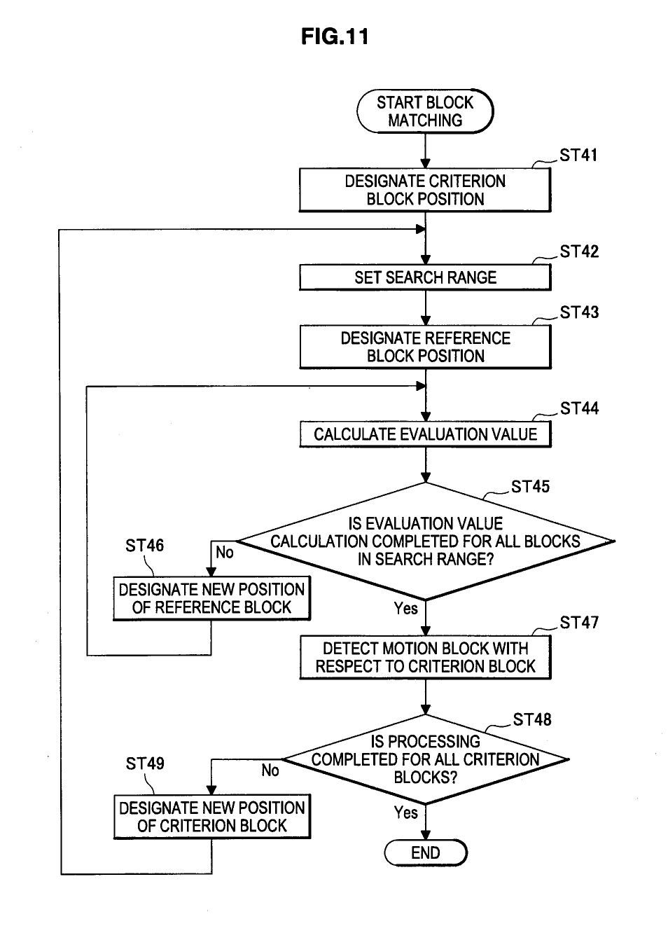

FIG. 11 is a flowchart illustrating processing in the block matching unit 41. In step ST41, the block matching unit 41 designates a criterion block position. The block matching unit 41 designates a criterion block position in motion vector detection for the low-bit criterion image, and the process proceeds to step ST42.

In step ST42, the block matching unit 41 sets a search range. The block matching unit 41 sets the search range for the low-bit reference image, and the flow proceeds to step ST43.

In step ST43, the block matching unit 41 designates a reference block position. The block matching unit 41 designates the reference block position in motion vector detection in the search range, and the flow proceeds to step ST44.

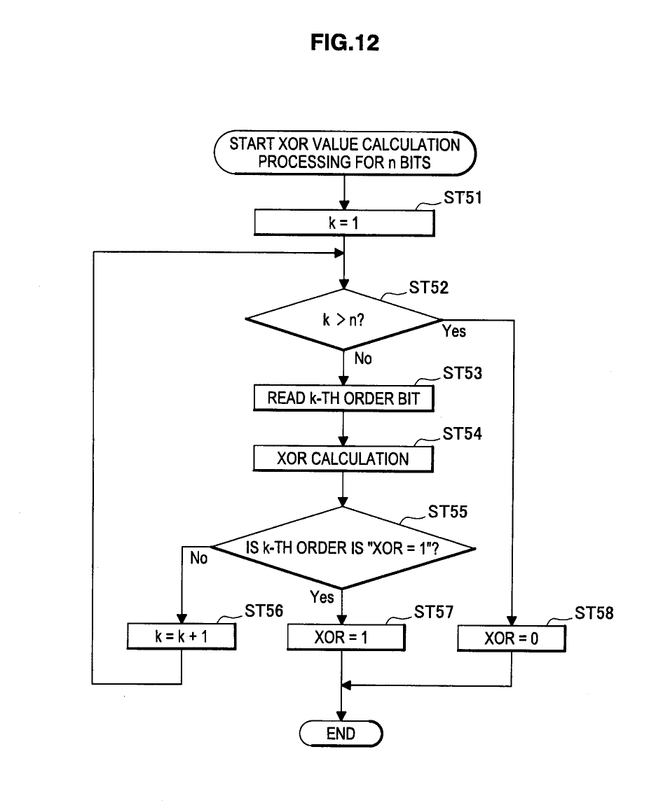

In step ST44, the block matching unit 41 calculates an evaluation value. The block matching unit 41 calculates the evaluation value from pixel data of the criterion block and reference block. The block matching unit 41 calculates the sum of absolute difference SAD, the sum of XOR SOX, and so on as the evaluation value. Also, if the low-bit criterion image and the low-bit reference image are n bits, XOR value calculation processing shown in FIG. 12 is performed to determine the XOR value for each pixel in the block.

In step ST51, the block matching unit 41 sets a parameter k representing a bit position to “k=1.” The block matching unit 41 sets the parameter k representing a bit position to “k=1” representing the least significant bit of pixel data of the low-bit criterion image and low-bit reference image, and the flow proceeds to step ST52.

In step ST52, the block matching unit 41 decides whether the parameter k is greater than n. If the block matching unit 41 finds that the parameter k is not greater than the most significant bit of the pixel data of the low-bit criterion image and low-bit reference image, the flow proceeds to step ST53. By contrast, if the block matching unit 41 finds that the parameter k is greater than the most significant bit of the pixel data of the low-bit criterion image and low-bit reference image, the flow proceeds to step ST58.

In step ST53, the block matching unit 41 reads a k-th order bit. The block matching unit 41 reads data of the k-th order bit from the pixel data of the low-bit criterion image and low-bit reference image, and the flow proceeds to step ST54.

In step ST54, the block matching unit 41 performs an XOR calculation. The block matching unit 41 performs the exclusive disjunction (XOR) calculation for the data of the k-th order bit read in step ST53, and the flow proceeds to step ST55.

In step ST55, the block matching unit 41 decides whether the k-th order is “XOR=1.” If the block matching unit 41 finds that the XOR of the k-th order bit calculated in step ST54 is “0,” the flow proceeds to step ST56. Also, if the block matching unit 41 finds that the XOR of the k-th order bit calculated in step ST54 is “1,” the flow proceeds to step ST57.

In step ST56, the block matching unit 41 performs a computation of “k=k+1” and updates the parameter k, and the flow proceeds back to step ST52.

In step ST57, the block matching unit 41 sets “XOR=1” as the XOR value of n bits and terminates processing.

In step ST58, the block matching unit 41 sets “XOR=0” as the XOR value of n bits and terminates processing.

By performing such processing, it is determined whether, in the pixel data of the low-bit criterion image and low-bit reference image, the respective bit values are the same from the least significant bit to the most significant bit. Here, if the bit values are not equal, the XOR value is set to “XOR=1.” By contrast, if all the bit values are equal, the XOR value is set to “XOR=0.” That is, if the n-bit pixel data of the low-bit criterion image and low-bit reference image are not equal, the XOR value of n bits is set to “XOR=1,” and, if the n-bit pixel data are equal, the XOR value of n bits is set to “XOR=0.”

In this way, even if the low-bit criterion image data and the low-bit reference image data are n bits, it is possible to obtain the XOR value.

Referring to FIG. 11, in step ST45, the block matching unit 41 decides whether a calculation of evaluation values for all blocks in the search range is completed. If the block matching unit 41 finds that the calculation of evaluation values for all blocks is not completed, the flow proceeds to step ST46, and, if the block matching unit 41 finds that the calculation of evaluation values for all blocks is completed, the flow proceeds to step ST47.

In step ST46, the block matching unit 41 designates a new position of the reference block. The block matching unit 41 designates the new position of the reference block in which an evaluation value calculation is not completed in the reference range, and the flow proceed back to step ST44.

In step ST47, the block matching unit 41 detects a motion block for the criterion block. The block matching unit 41 decides a reference image block position having the highest similarity to the criterion image block from the calculated evaluation values and calculates a local motion vector from a coordinate difference between this decided reference image block position and the criterion image block position, and the flow proceeds to step ST48.

In step ST48, the block matching unit 41 decides whether processing is completed for all criterion blocks. If the block matching unit 41 finds that there remains a criterion block in which processing is not completed, the flow proceeds to step ST49, and, if the block matching unit 41 finds that processing is completed for all criterion blocks, the block matching processing is terminated.

In step ST49, the block matching unit 41 designates a new position of the criterion block. The block matching unit 41 designates the new position of the criterion block in which a local motion vector detection is not completed, and the process proceeds back to step ST42.

By performing such processing, it is possible to detect a local motion vector for each criterion block in the low-bit criterion image.

### [1-5. Configuration and Operation of First Reliability Calculation Unit]

The first reliability calculation unit 42 calculates the reliability of the local motion vector LMV detected in the block matching unit 41, using the evaluation value supplied from the block matching unit 41. The first reliability calculation unit 42 outputs the calculated reliability to the reliability integration unit 44. In the following, a case will be explained using the sum of absolute difference (SAD) as the evaluation value EV. Also, if the sum of absolute difference (SAD) is used, the evaluation value providing the highest similarity is “0.” Therefore, if the sum of absolute difference (SAD) is used, the first reliability calculation unit 42 calculates the reliability using minimal values.

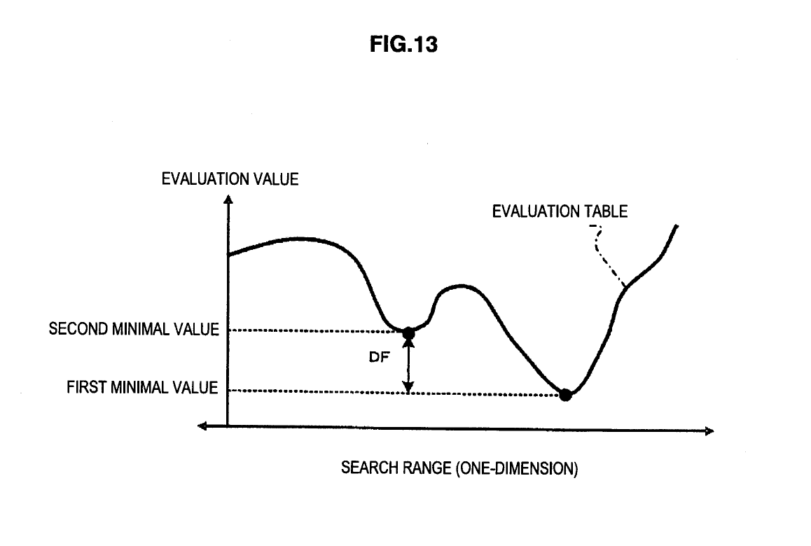

FIG. 13 exemplarily illustrates relationships between a search range and evaluation values in a one-dimensional evaluation value table. If there is a small difference between a first minimal value of the smallest evaluation value EV among minimal values and a second minimal value of the second smallest evaluation value EV among minimal values, it is difficult to decide which of the first minimal value and the second minimal value is a correct position corresponding to a local motion vector. However, if there is a large difference between the first minimal value and the second minimal value, the position of the first minimal value is more reliable as a position corresponding to the local motion vector. Therefore, using the difference between the first minimal value and the second minimal value as a reliability decision value, it is decided that the reliability is higher in a larger reliability decision value and lower in a smaller reliability decision value. For example, when the reliability is expressed by binary information and a difference value DF (−second minimal value−first minimal value) is used as the reliability decision value, if the reliability decision value is equal to or greater than a threshold, it is decided that the reliability is high and reliability RV1 is set to “1.” Also, if the reliability decision value is less than the threshold, it is decided that the reliability is low and the reliability RV1 is set to “0.” Also, if the reliability is expressed by multivalued information, the difference value DF is divided by the theoretically maximum difference value DFₘₐₓ and a reliability decision value of the division result is used as the reliability RV1. Here, regarding the minimal values, if a two-dimensional evaluation value table is used, pixel values of pixels having smaller pixel values than peripheral pixels on the left, right, top and bottom thereof are used as the minimal values. Also, regarding the minimal values, it is assumed that only the first minimal value exist and the second minimal value does not exist. In this case, regarding the second minimal value, the theoretically maximum value may be used as the second minimal value. When the two-dimensional evaluation value table is used, the theoretically maximum value is the maximum value DFₘₐₓ(=horizontal block width×vertical block width×pixel luminance maximum value).

Also, the reliability RV1 is not limited to the difference between the first minimal value and the second minimal value, and can be determined according to a ratio of the second minimal value and the first minimal value. For example, (1−first minimal value/second minimal value) is calculated as the reliability decision value. Here, the reliability decision value becomes large when the ratio of the first minimal value to the second minimal value is small, and the reliability decision value becomes small when the first minimal value is closer to the second minimal value. Therefore, when the reliability decision value and the threshold are compared and the reliability decision value is equal to or greater than the threshold, it is decided that the reliability is high and the reliability RV1 is set to “1.” Also, if the reliability decision value is less than the threshold, it is decided that the reliability is low and the reliability RV1 is set to “0.” Also, when the reliability is expressed by multivalued information, it may be possible to use the reliability decision value as the reliability RV1.

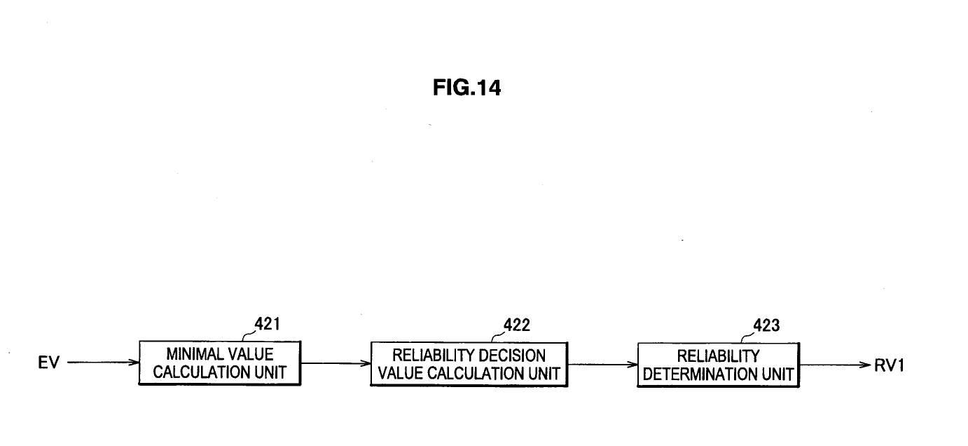

FIG. 14 exemplarily illustrates a configuration of the first reliability calculation unit 42. The first reliability calculation unit 42 has a minimal value calculation unit 421, a reliability decision value calculation unit 422 and a reliability determination unit 423. The minimal value calculation unit 421 calculates the first minimal value and the second minimal value from the evaluation value table. As described above, the reliability decision value calculation unit 422 calculates the reliability decision value from the first minimal value and the second minimal value. The reliability determination unit 423 determines the reliability based on the calculated reliability decision value. For example, the reliability decision value and a threshold are compared, and, based on the comparison result, the reliability RV1 of binary information is generated. Also, if the reliability of multivalued information is generated, it may be possible to use the reliability decision value as the reliability RV1.

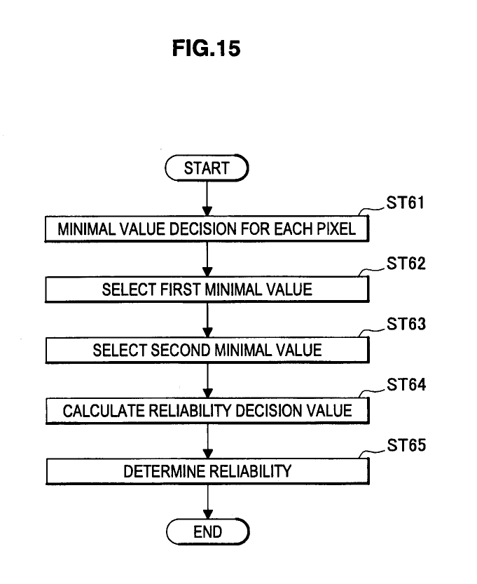

FIG. 15 is a flowchart illustrating processing in the first reliability calculation unit. In step ST61, the first reliability calculation unit 42 performs a minimal value decision for each pixel. The first reliability calculation unit 42 decides whether a minimal value is provided, for each pixel in the evaluation value table, and the flow proceeds to step ST62. Regarding decision as to whether a minimal value is provided, for example, when the evaluation value table is a two-dimensional table, the pixel value of a pixel having a smaller pixel value than the pixel values of peripheral pixels on the left, right, top and bottom thereof is decided as the minimal value.

In step ST62, the first reliability calculation unit 42 selects a first minimal value. The first reliability calculation unit 42 selects a minimal value having the smallest evaluation value EV among the minimal values decided in step ST61, as the first minimal value, and the flow proceeds to step ST63.

In step ST63, the first reliability calculation unit 42 selects a second minimal value. The first reliability calculation unit 42 selects a minimal value having the second smallest evaluation value among the minimal values decided in step ST61, as the second minimal value, and the flow proceeds to step ST64. Here, the processing in step ST62 and the processing in step ST63 may be performed in parallel or the processing in step ST63 may be performed first.

In step ST64, the first reliability calculation unit 42 calculates a reliability decision value. The first reliability calculation unit 42 calculates the reliability decision value form the first minimal value and the second minimal value, and the flow proceeds to step ST65. For example, the first reliability calculation unit 42 uses a difference value, which is obtained by subtracting the first minimal value from the second minimal value, as the reliability decision value. Also, based on the ratio of the first minimal value to the second minimal value, the first reliability calculation unit 42 may calculate the reliability decision value as described above.

In step ST65, the first reliability calculation unit 42 determines the reliability based on the reliability decision value. For example, in a case where the reliability is binary data, if the reliability decision value calculated in step ST64 and a threshold are compared and the reliability decision value is less than the threshold, it is decided that the reliability is low and the reliability RV1 is set to “0.” By contrast, if the reliability decision value is equal to or greater than the threshold, it is decided that the reliability is high and the reliability RV1 is set to “1.” When the reliability is a continuous value, it may be possible to use the reliability decision value as the reliability.

Also, when a sum of squared difference (“SSD”) is used as an evaluation value, the sum of squared difference becomes closer to “0” in higher similarity. Therefore, by performing the same processing as in the case of using the sum of absolute difference, it is possible to calculate the reliability. Also, when the normalized cross-correlation (“NCC”) is used, the normalized cross-correlation is a value within a range of “−1 to +1” and becomes closer to “1” in higher similarity. Therefore, when the normalized cross-correlation is used, the reliability is calculated using a maximal value.

### [1-6. Configuration and Operation of Second Reliability Calculation Unit]

The second reliability calculation unit 43 calculates a feature amount for each block from a low-bit image and calculates, from the feature amounts, the reliability of the local motion vector detected in the block matching unit 41.

Table 1 shows relationships between low-bit image blocks and the reliability of local motion vectors. Here, Table 1 shows a case where the low-bit image is a one-bit image. Also, for example, an eight-bit image before low-bit conversion is described together as a reference. When one-bit-image blocks have a distinctive pattern or eight-bit-image blocks are a distinctive texture area, a detected local motion vector shows a correct motion vector. Therefore, the detected local motion vector has high reliability. When the one-bit-image blocks have a repetitive pattern or the eight-bit-image blocks are a repetitive pattern area, the detected local motion vector may not show a correct motion vector because a pattern is repeated. Therefore, the detected local motion vector has low reliability. When the one-bit-image blocks have a random pattern or the eight-bit-image blocks are a flat area, the detected local motion vector may not show a correct motion vector because there is no remarkable pattern feature. Therefore, the detected local motion vector has low reliability.

TABLE 1

| | One-bit-image block | Eight-bit-image block | Reliability |
|---|---|---|---|
| Correct LMV | Distinctive pattern | Distinctive texture area | High |
| Erroneous | Edge (repetitive | Repetitive pattern area | Low |
| LMV | pattern) | | |
| Erroneous | Random pattern | Flat area | Low |
| LMV | | | |

Therefore, the second reliability calculation unit 43 finds a feature amount according to a block pattern and calculates the reliability of the local motion vector from the feature amount. The second reliability calculation unit 43 finds angle information related to an image luminance gradient as a two-dimensional vector and calculates a feature amount based on the angle information. In this case, the second reliability calculation unit 43 selects two-dimensional vector Gij corresponding to pixel position (i, j) from Table 2. Here, it is presumed that the pixel level of pixel position (i, j+1) is T(i, j+1). Further, it is presumed that the pixel levels of pixel positions (i, j−1) (i+1, j) and (i−1, j) are T(i, j−1), T(i+1, j) and T(i−1, j).

TABLE 2

| | | T (i, j + 1) − T (i, j − 1) | | |
|---|---|---|---|---|
| | | −1 | 0 | 1 |
| T (i + 1, j) − T (i − 1, j) | −1 | (−√2/2, −√2/2) | (−1, 0) | (−√2/2, √2/2) |
| | 0 | (0, −1) | — | (0, 1) |
| | 1 | (√2/2, −√2/2) | (1, 0) | (√2/2, √2/2) |

For example, in the case of “(T(i, j+1)−T(i, j−1))=−1,(T(i+1, j)−T(i−1, j))=0,” from Table 2, the two-dimensional vector Gij is Gij=(G1ij, G2ij)=(−1, 0).

Also, the second reliability calculation unit 43 calculates standard deviation std of the two-dimensional vector Gij according to Equation 9 and provides it as a feature amount.

$$\begin{matrix}[ Expression 8 ] & \\ std = \sqrt{\sum {( {G}_{ij}^{1} - \frac{Σ {G}_{ij}^{1}}{n} )}^{2} + \sum {( {G}_{ij}^{2} - \frac{Σ {G}_{ij}^{2}}{n} )}^{2}} & ( 9 )\end{matrix}$$

The second reliability calculation unit 43 compares the feature amount calculated as above and a threshold to determine the reliability. For example, if the feature amount (standard deviation) is less than the threshold, the second reliability calculation unit 43 decides that the reliability is high and sets reliability RV2 to “1,” and, if the feature amount (standard deviation) is equal to or greater than the threshold, the second reliability calculation unit 43 decides that the reliability is low and sets the reliability RV2 to “0.” Here, the reliability is not limited to binary information and may be multivalued information. For example, when the theoretical maximum value of the standard deviation is std_max, a value calculated in Equation 10 may be provided as the reliability.

Reliability=(1−std)/std_{—max} (10)

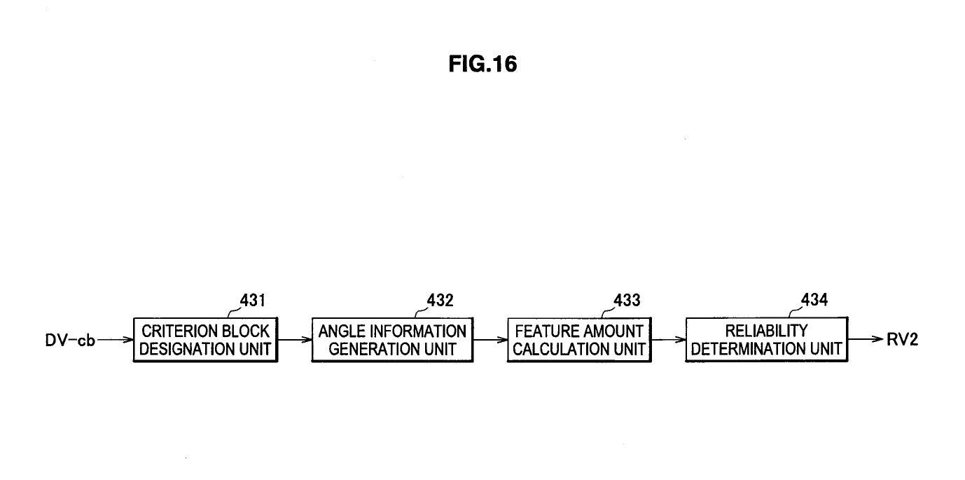

FIG. 16 illustrates a configuration of the second reliability calculation unit 43. The second reliability calculation unit 43 has a criterion block designation unit 431, an angle information generation unit 432, a feature amount calculation unit 433 and a reliability determination unit 434. The criterion block designation unit 431 designates a criterion block to calculate the reliability. The angle information generation unit 432 generates angle information from Table 2, using criterion block pixels. The feature amount calculation unit 433 performs, for example, a computation of Equation 9 using the generated angle information and calculates a standard deviation as a feature amount. The reliability determination unit 434 determines the reliability RV2 based on the calculated feature amount. The reliability determination unit 434 compares the feature amount and a threshold to determine the reliability RV2 based on the comparison result. Also, the reliability determination unit 434 may determine the reliability RV2 according to a ratio of the feature amount calculated in the feature amount calculation unit 433 to the theoretical maximum value of the feature amount.

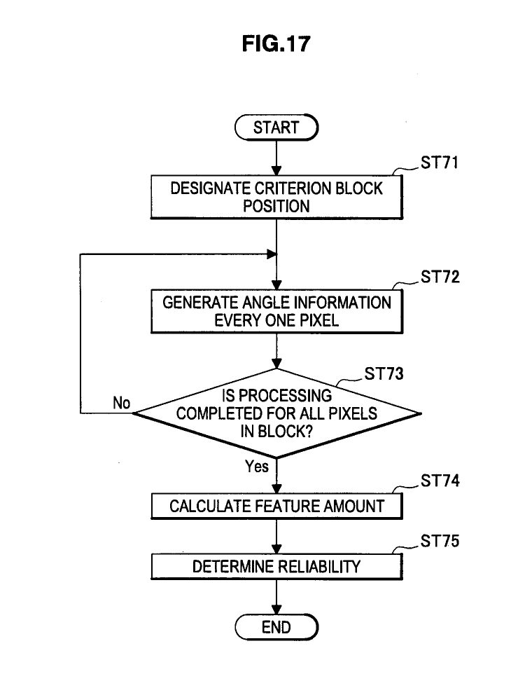

FIG. 17 is a flowchart illustrating processing in the second reliability calculation unit 43. In step ST71, the second reliability calculation unit 43 designates a criterion block position to calculate the reliability, and the flow proceeds to step ST72.

In step ST72, the second reliability calculation unit 43 generates angle information per pixel in the block. The second reliability calculation unit 43 generates the angle information for each pixel in the block, and the flow proceeds to step ST73.

In step ST73, the second reliability calculation unit 43 decides whether angle information generation is completed for all pixels in the block. If the second reliability calculation unit 43 finds that there is a pixel for which angle information is not generated in the block, the flow proceeds back to step ST72 to generate angle information for the pixel for which angle information is not generated. By contrast, if the second reliability calculation unit 43 finds that angle information generation for all pixels in the block is completed, the flow proceeds to step ST74.

In step ST74, the second reliability calculation unit 43 calculates a feature amount. The second reliability calculation unit 43 calculates, for example, the standard deviation of the angle information for all pixels calculated in step ST72, as a feature amount, and the flow proceeds to step ST75.

In step ST75, the second reliability calculation unit 43 determines the reliability based on the feature amount. For example, when the reliability is expressed by binary information, the second reliability calculation unit 43 compares the feature amount calculated in step ST74 and a threshold, and, if the feature amount is equal to greater than the threshold, decides that the reliability is low and sets the reliability RV2 to “0.” By contrast, if the feature amount is less than the threshold, it is decided that the reliability is high and the reliability RV2 is set to “1.” When the reliability is expressed by multivalued information, the second reliability calculation unit 43 performs a computation of Equation 10 and determines the reliability RV2.

### [1-7. Configuration and Operation of Reliability Integration Unit]

The reliability integration unit 44 integrates the reliability RV1 calculated in the first reliability calculation unit 42 and the reliability RV2 calculated in the second reliability calculation unit 43, and determines the reliability of the local motion vector detected in the block matching unit 41. The reliability integration unit 44 outputs the integrated reliability RVT to the global motion vector calculation unit 51.

When the reliability is binary information, the reliability integration unit 44 calculates the logical disjunction or logical product of two reliabilities as an integration result. In a case where the logical disjunction calculation result of two reliabilities is used, when it is decided that one of two reliabilities is high, it is decided that the reliability is high. Also, in a case where the logical product of two reliabilities is used, when it is decided that both of two reliabilities are high, it is decided that the reliability is high.

Also, when the reliability is multivalued information, for example, the reliability integration unit 44 multiples two reliabilities and provides the multiplication result as the integrated reliability RVT. Here, two reliabilities used in the reliability integration unit 44 are normalized in the first reliability calculation unit 42 and the second reliability calculation unit 43, respectively, such that these reliabilities are within a range of “0” to “1,” for example.

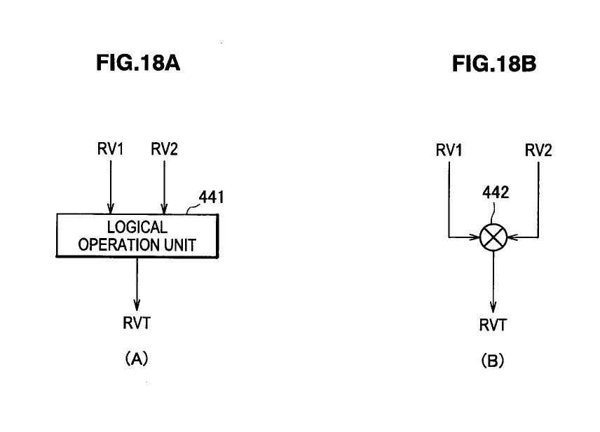

FIGS. 18A and 18B illustrate a configuration of the reliability integration unit, FIG. 18A illustrates a case where the reliability is binary information and FIG. 18B illustrates a case where the reliability is multivalued information.

When the reliability is binary information, the reliability integration unit 44 includes a logical operation unit 441. The logical operation unit 441 performs a logical operation of the reliability RV1 given from the first reliability calculation unit 42 and the reliability RV2 given from the second reliability calculation unit 43, and outputs the operation result as the reliability RVT to the global motion vector calculation unit 51. Also, when the reliability is multivalued information, the reliability integration unit 44 includes a multiplier 442. The multiplier 442 multiplies the normalized reliability RV1 given from the first reliability calculation unit 42 and the normalized reliability RV2 given from the second reliability calculation unit 43, and outputs the multiplication result as the reliability RVT to the global motion vector calculation unit 51.

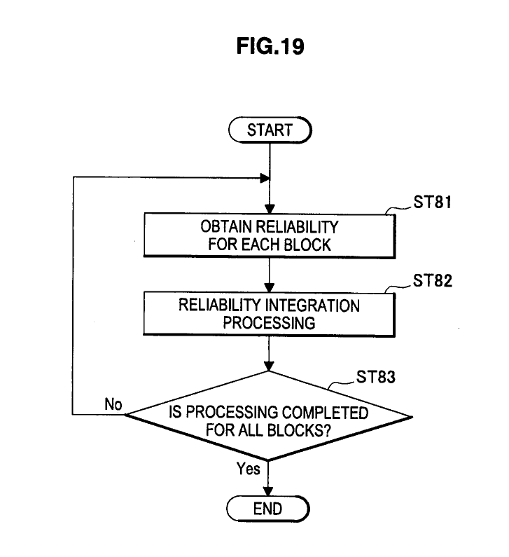

FIG. 19 is a flowchart illustrating processing performed in the reliability integration unit. In step ST81, the reliability integration unit 44 obtains the reliability for each block. The reliability integration unit 44 obtains the reliability RV1 calculated in the first reliability calculation unit 42 and the reliability RV2 calculated in the second reliability calculation unit 43 for each block, and the flow proceeds to step ST82.

In step ST82, the reliability integration unit 44 performs reliability integration processing. The reliability integration unit 44 performs a logical operation or multiplication of reliabilities as above to integrate the reliabilities, and the flow proceeds to step ST83.

In step ST83, the reliability integration unit 44 decides whether processing is completed for all blocks. If there is a block for which reliability integration processing is not performed, the flow proceeds back to step ST81, and the reliability integration unit 44 repeats the processing in step ST81 and subsequent steps for the block for which the reliability integration processing is not performed. By contrast, if there is no block for which the reliability integration processing is not performed, the reliability integration unit 44 terminates the reliability integration processing.

### [1-8. Regarding Global Motion Vector Calculation Unit]

Next, the global motion vector calculation unit 51 will be explained. From the local motion vector LMV detected for each of blocks made by dividing one image into a plurality of blocks, the global motion vector calculation unit 51 selects the local motion vector LMV of high reliability based on the reliability RVT. For example, the global motion vector calculation unit 51 selects the local motion vector LMV of the reliability RVT of “1.” The global motion vector calculation unit 51 calculates the global motion vector GMV from the selected local motion vector LMV. Thus, as a method of selecting a local motion vector of high reliability and calculating a global motion vector from the selected local motion vector, it is possible to adopt, for example, a method disclosed in “IEEE Transactions on Consumer Electronics, Vol. 52, No. 2, MAY 2006.”

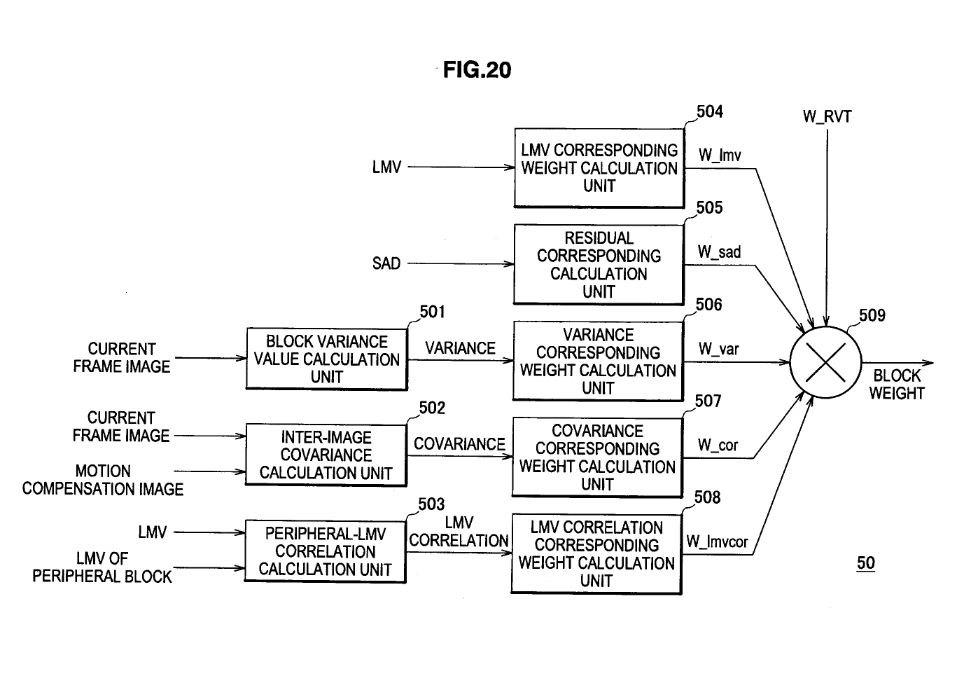

Also, the local motion vector LMV detected in a block unit is weighted according to the reliability RVT, and the global motion vector calculation unit 51 may calculate a global motion vector from the weighted local motion vector LMV. Thus, by using a method of calculating the global motion vector from the local motion vector LMV weighted according to the reliability RVT, in a case where the reliability is multivalued information, it is possible to perform weighting more precisely than a case where the reliability is binary information. As a method of calculating a global motion vector from the local motion vector LMV weighted according to the reliability RVT, it is possible to adopt, for example, a method disclosed in “JP-A-2009-65332.” In this case, a block weight calculation unit 50 shown in FIG. 20 is provided, and the global motion vector calculation unit 51 calculates the global motion vector from the weighted local motion vector LMV.

The block weight calculation unit 50 has a block variance value calculation unit 501, an inter-image covariance calculation unit 502 and a peripheral-LMV correlation calculation unit 503. Further, the block weight calculation unit 50 has an LMV corresponding weight calculation unit 504, a residual corresponding weight calculation unit 505, a variance corresponding weight calculation unit 506, a covariance corresponding weight calculation unit 507, an LMV correlation corresponding weight calculation unit 508 and a multiplier 509.

The block weight calculation unit 50 calculates an LMV corresponding weight [W_lmv] in the LMV corresponding weight calculation unit 504 and a residual corresponding weight [W_sad] in the residual corresponding weight calculation unit 505. Further, the block weight calculation unit 50 calculates a variance corresponding weight [W_var] in the variance corresponding weight calculation unit 506, a covariance corresponding weight [W_cor] in the covariance corresponding weight calculation unit 507, and an LMV correlation corresponding weight [W_lmvcor] in the LMV correlation corresponding weight calculation unit 508. The block weight calculation unit 50 employs a configuration of multiplying these block weights and a reliability RVT corresponding weight [W_RVT] as shown in Equation 11 and calculating a final block weight [W_{—block].}

W_block=W_{—}lmv×W_sad×W_{—}var×W_{—}cor×W_{—}lmvcor×W_{—}RVT (11)

The global motion vector calculation unit 51 calculates the global motion vector GMV based on the block weight [W_block] calculated in the block weight calculation unit 50 and the local motion vector LMV corresponding to each block.

The global motion vector calculated in the global motion vector calculation unit 51 is output to the motion compensation unit 61, and the motion compensation unit 61 performs motion compensation of the reference image according to the global motion vector and outputs the motion compensation image.

Thus, according to the first embodiment, it is possible to calculate a local motion vector and the reliability of the local motion vector using a low-bit image, at low cost. Further, by using the local motion vector and the reliability, it is possible to detect a global motion vector such as an imaging apparatus motion at higher performance.

### 2. Second Embodiment

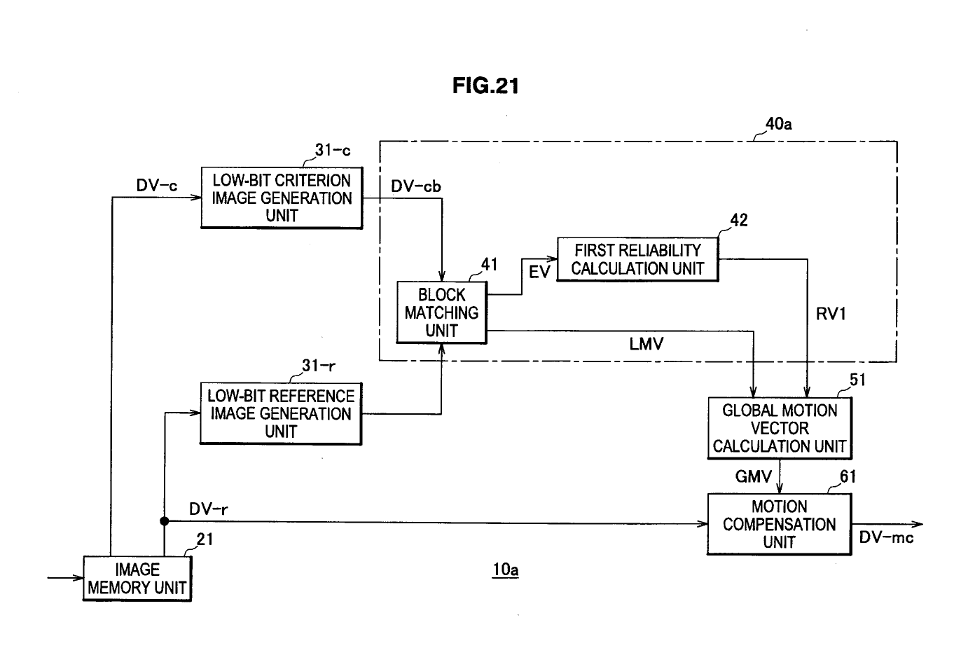

By the way, although the first reliability calculation unit to calculate reliability from an evaluation value and the second reliability calculation unit to calculate reliability from a low-bit image are provided in the first embodiment, it may be possible to employ a configuration having one of the reliability calculation units. Next, in the second embodiment, FIG. 21 illustrates a configuration in which only the first reliability calculation unit to calculate reliability from an evaluation value is provided as a reliability calculation unit. Here, in FIG. 21, the same components as in FIG. 1 have the same reference numerals.

An information processing apparatus 10a has the image memory unit 21 to store input image data, and the low-bit criterion image generation unit 31-c and the low-bit reference image generation unit 31-r to reduce the number of bits assigned to pixels. Also, the information processing apparatus 10a has a motion vector information generation unit 40a to calculate a local motion vector and reliability, and a global motion vector calculation unit 51 to calculate a global motion vector using the calculated local motion vector and reliability. Further, the information processing apparatus 10a has the motion compensation unit 61 to perform motion compensation using the calculated global motion vector.

The image memory unit 21 stores image data of a criterion image and reference image. The image memory unit 21 outputs the stored criterion image data to the low-bit criterion image generation unit 31-c. The image memory unit 21 outputs the stored reference image data to the low-bit reference image generation unit 31-r and the motion compensation unit 61.

The low-bit criterion image generation unit 31-c performs bit number reduction processing on the criterion image data and generates low-bit criterion image data. Also, the low-bit criterion image generation unit 31-c outputs the generated low-bit criterion image data to the block matching unit 41 of the motion vector information generation unit 40a. For example, the low-bit criterion image generation unit 31-c performs bit number reduction processing on criterion image data of eight bits and outputs low-bit criterion image data of one bit to the block matching unit 41.

The low-bit reference image generation unit 31-r performs bit number reduction processing on the reference image data and generates a low-bit reference image having the same bit number as that of the low-bit criterion image. The low-bit reference image generation unit 31-r outputs image data of the generated low-bit reference image to the block matching unit 41 of the motion vector information generation unit 40a.

The motion vector information generation unit 40a has the block matching unit 41 and the first reliability calculation unit 42.

The block matching unit 41 performs block matching using the low-bit criterion image data outputted from the low-bit criterion image generation unit 31-c and the low-bit reference image data outputted from the low-bit reference image generation unit 31-r. The block matching unit 41 detects a local motion vector based on an evaluation value calculated by performing block matching. The block matching unit 41 outputs the detected local motion vector LMV to the global motion vector calculation unit 51. At the same time, the evaluation value is output to the first reliability calculation unit 42.

The first reliability calculation unit 42 calculates the reliability of the local motion vector detected in the block matching unit 41, using the evaluation value supplied from the block matching unit 41. The first reliability calculation unit 42 outputs the calculated reliability to the global motion vector calculation unit 51.

The global motion vector calculation unit 51 calculates a global motion vector using the local motion vector and the reliability supplied from the motion vector information generation unit 40, and outputs it to the motion compensation unit 61. The motion compensation unit 61 performs motion compensation of the reference image according to the global motion vector calculated in the global motion vector calculation unit 51, and outputs the motion compensation image.

Thus, even in the second embodiment, it is possible to calculate a local motion vector and reliability and calculate a global motion vector using the calculated local motion vector and reliability, so that it is possible to detect the global motion vector at low cost. Further, the reliability of the local motion vector is used, so that it is possible to calculate the global motion vector at higher performance.

### 3. Third Embodiment

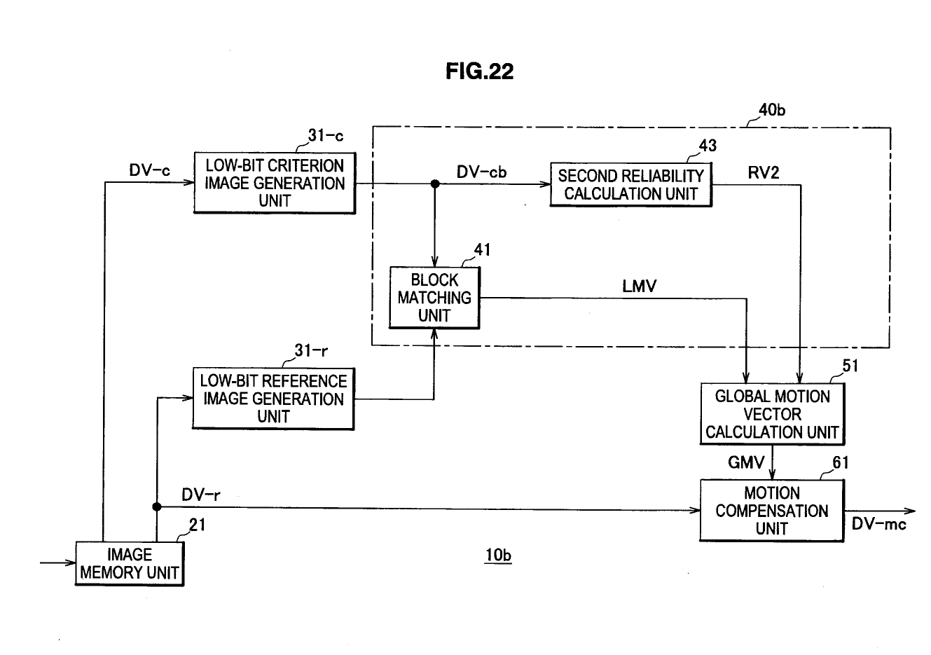

Next, in the third embodiment, FIG. 22 illustrates a configuration where only the second reliability calculation unit to calculate reliability from a low-bit image is provided as a reliability calculation unit. Also, in FIG. 22, the same components as in FIG. 1 have the same reference numerals.

An information processing apparatus 10b has the image memory unit 21 to store input image data, and the low-bit criterion image generation unit 31-c and the low-bit reference image generation unit 31-r to reduce the number of bits assigned to pixels. Also, the information processing apparatus 10b has a motion vector information generation unit 40b to detect a local motion vector and calculate the reliability of the detected local motion vector, and the global motion vector calculation unit 51 to calculate a global motion vector using the detected local motion vector and the calculated reliability. Further, the information processing apparatus 10b has the motion compensation unit 61 to perform motion compensation using the calculated global motion vector.

The image memory unit 21 stores image data of a criterion image and reference image. The image memory unit 21 outputs the stored criterion image data to the low-bit criterion image generation unit 31-c. The image memory unit 21 outputs the stored reference image data to the low-bit reference image generation unit 31-r and the motion compensation unit 61.

The low-bit criterion image generation unit 31-c performs bit number reduction processing on the criterion image data and generates low-bit criterion image data. Also, the low-bit criterion image generation unit 31-c outputs the generated low-bit criterion image data to the block matching unit 41 of the motion vector information generation unit 40b. For example, the low-bit criterion image generation unit 31-c performs bit number reduction processing on criterion image data of eight bits and outputs low-bit criterion image data of one bit to the block matching unit 41.

The low-bit reference image generation unit 31-r performs bit number reduction processing on the reference image data and generates a low-bit reference image having the same bit number as that of the low-bit criterion image. The low-bit reference image generation unit 31-r outputs image data of the generated low-bit reference image to the block matching unit 41 of the motion vector information generation unit 40b.

The motion vector information generation unit 40b has the block matching unit 41 and the second reliability calculation unit 43.

The block matching unit 41 performs block matching using the low-bit criterion image data outputted from the low-bit criterion image generation unit 31-c and the low-bit reference image data outputted from the low-bit reference image generation unit 31-r. The block matching unit 41 detects a local motion vector based on an evaluation value calculated by performing block matching. The block matching unit 41 outputs the detected local motion vector LMV to the global motion vector calculation unit 51.

The second reliability calculation unit 43 calculates reliability using the low-bit criterion image. The second reliability calculation unit 43 calculates a feature amount in a block unit using the low-bit image and, from the feature amount, calculates the reliability of the local motion vector detected in the block matching unit 41. The second reliability calculation unit 43 outputs the calculated reliability to the global motion vector calculation unit 51.

The global motion vector calculation unit 51 calculates a global motion vector using the local motion vector and the reliability supplied from the motion vector information generation unit 40, and outputs it to the motion compensation unit 61.

Here, the information processing apparatus 10b has the motion compensation unit 61, and the motion compensation unit 61 performs motion compensation of the reference image according to the global motion vector calculated in the global motion vector calculation unit 51, and outputs the motion compensation image.

Thus, even in the third embodiment, it is possible to detect a local motion vector, calculate reliability and calculate a global motion vector using the detected local motion vector and the calculated reliability, so that it is possible to detect the global motion vector at low cost. Further, the reliability of the local motion vector is used, so that it is possible to calculate the global motion vector at higher performance.

<4. Regarding case where processing is performed by program>

The above-described series of processing may be performed by hardware or software. When a series of processing is performed by the software, a computer is used in which programs constituting the software are embedded in dedicated hardware. In addition, for example, the software is installed from a program recording medium to a general personal computer which can execute various kinds of functions by installing various kinds of programs.

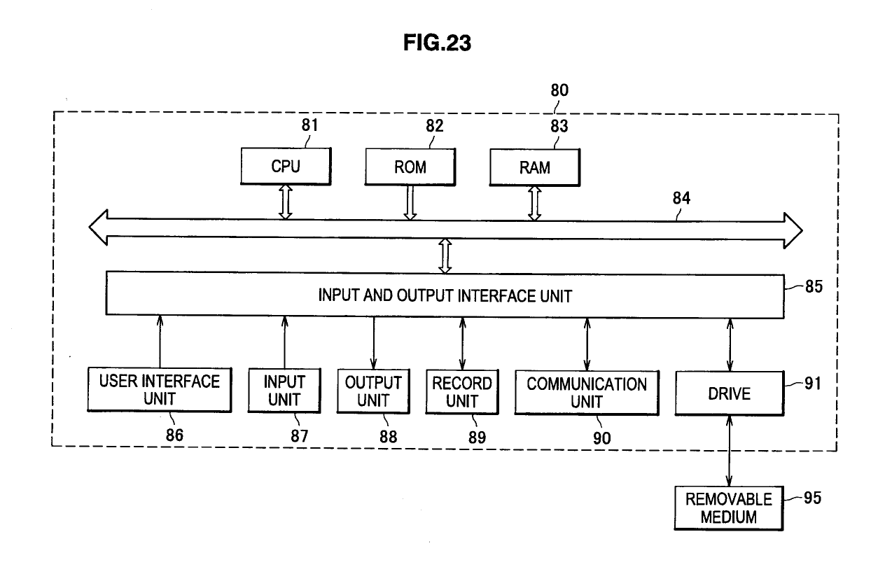

FIG. 23 illustrates a configuration example of hardware of a computer which performs the above-described series of processing by programs.

In a computer 80, a central processing unit (CPU) 81, a read only memory (ROM) 82, and a random access memory (RAM) 83 are connected to each other via a bus 84.

The bus 84 is also connected to an input and output interface 85. The input and output interface 85 is connected to a user interface unit 86 constituted by a keyboard, a mouse, or the like, an input unit 87 for inputting image data, an output unit 88 constituted by a display or the like, and a recording unit 89 constituted by a hard disc or a nonvolatile memory, or the like. Also, the input and output interface 85 is connected to a communication unit 90 constituted by a network interface or the like, and a drive 91 which drives a removable medium 95 such as a magnetic disk, an optical disc, a magnetic optical disc and a semiconductor memory.

In the computer configured as above, for example, the CPU 81 loads a program recorded in the record unit 89 to the RAM 83 via the input and output interface 85 and the bus 84 and executes the program, thereby performing the above-described series of processing.

The program executed by the computer (or the CPU 81) is recorded in the removable medium 95 which is a package medium constituted by a magnetic disk (including a flexible disc), an optical disc (including a CD-ROM (Compact Disc-Read Only Memory) and DVD (Digital Versatile Disc)), a magnetic optical disc, a semiconductor memory or the like. Alternatively, it is provided using a wired or wireless transmission medium such as a local area network, the Internet and digital satellite broadcasting.

The program can be installed in the record unit 89 through the input and output interface 85 by installing the removable medium 95 in the drive 91. Also, the program can be received by the communication unit 90 via the wired or wireless transmission medium, and may be installed in the record unit 89. Alternately, the program can be installed in the ROM 82 or the record unit 89 in advance.

Here, the program executed by the computer may be a program where processing is performed in a time series according to the order described in this specification, or may be a program executed in parallel or a program where processing is performed at a necessary timing such as when accessed.

It should be understood by those skilled in the art that various modifications, combinations, sub-combinations and alterations may occur depending on design requirements and other factors insofar as they are within the scope of the appended claims or the equivalents thereof.

Additionally, the present technology may also be configured as below.

(1)

An information processing apparatus comprising:

a low-bit image generation unit configured to reduce a bit number assigned to a pixel in a criterion image and a reference image and generate a low-bit criterion image and a low-bit reference image; and

a motion vector information generation unit configured to detect a local motion vector, which is a motion vector for each of blocks constituting an image, from the low-bit criterion image and the low-bit reference image, and calculate a reliability of the detected local motion vector.

(2)

The information processing apparatus according to (1),

wherein the motion vector information generation unit detects the local motion vector by block matching, and calculates the reliability using an evaluation value used to detect the local motion vector and/or the low-bit criterion image.

(3)

The information processing apparatus according to (2),

wherein, in a case of using the evaluation value closer to a predetermined value in a higher similarity between blocks of the low-bit criterion image and the low-bit reference image and calculating the reliability from the evaluation value, the motion vector information generation unit calculates the reliability based on a difference between a first extreme value at which the evaluation value is the closest to the predetermined value and a second extreme value at which the evaluation value is the second closest to the predetermined value.

(4)

The information processing apparatus according to (3),

wherein the motion vector information generation unit provides a higher reliability when the difference becomes larger.

(5)

The information processing apparatus according to any one of (2) to (4),

wherein, in a case of calculating the reliability using the low-bit criterion image, the motion vector information generation unit calculates the reliability based on angle information related to a luminance gradient of a block image.

(6)

The information processing apparatus according to (5),

wherein the motion vector information generation unit provides a higher reliability when variability in the angle information becomes less.

(7)

The information processing apparatus according to any one of (2) to (6),

wherein, in a case of calculating a reliability based on the evaluation value and a reliability based on the low-bit criterion image, the motion vector information generation unit integrates the two reliabilities to provide one reliability.

(8)

The information processing apparatus according to (7),

wherein, in a case where the reliability based on the evaluation value and the reliability based on the low-bit criterion image are binary information, the motion vector information generation unit performs a logical operation of the two reliabilities to integrate the reliabilities, and, in a case where the reliability based on the evaluation value and the reliability based on the low-bit criterion image are multivalued information, the motion vector information generation unit multiplies the two reliabilities to integrate the reliabilities.

(9)

The information processing apparatus according to any one of (1) to (8), further comprising:

a global motion vector calculation unit configured to calculate a global motion vector, which is one image-unit motion vector between the criterion image and the reference image, from the local motion vector and the reliability.

According to the information processing apparatus, information processing method and program of the present technology, reduction of a bit number assigned to a pixel is performed for a criterion image and a reference image to generate a low-bit criterion image and a low-bit reference image. Further, from the generated low-bit criterion image and low-bit reference image, a local motion vector which is the motion vector for each of blocks constituting an image is detected. Further, the reliability of the detected local motion vector is calculated. Therefore, it is possible to detect the local motion vector in a simple configuration. Further, since the reliability of the local motion vector is calculated, it is possible to detect a global motion vector at higher accuracy based on the local motion vector and the reliability, so that, for example, an imaging apparatus or an image processing apparatus that performs coding or image processing of image data are applicable.

The present disclosure contains subject matter related to that disclosed in Japanese Priority Patent Application JP 2011-092576 filed in the Japan Patent Office on Apr. 19, 2011, the entire content of which is hereby incorporated by reference.

What is claimed is:

1. An information processing apparatus comprising:
a low-bit image generation unit configured to reduce a bit number assigned to a pixel in a criterion image and a reference image and generate a low-bit criterion image and a low-bit reference image; and
a motion vector information generation unit configured to detect a local motion vector, which is a motion vector for each of blocks constituting an image, from the low-bit criterion image and the low-bit reference image, and calculate a reliability of the detected local motion vector.

2. The information processing apparatus according to claim 1,
wherein the motion vector information generation unit detects the local motion vector by block matching, and calculates the reliability using an evaluation value used to detect the local motion vector and/or the low-bit criterion image.

3. The information processing apparatus according to claim 2,
wherein, in a case of using the evaluation value closer to a predetermined value in a higher similarity between blocks of the low-bit criterion image and the low-bit reference image and calculating the reliability from the evaluation value, the motion vector information generation unit calculates the reliability based on a difference between a first extreme value at which the evaluation value is the closest to the predetermined value and a second extreme value at which the evaluation value is the second closest to the predetermined value.

4. The information processing apparatus according to claim 3,
wherein the motion vector information generation unit provides a higher reliability when the difference becomes larger.

5. The information processing apparatus according to claim 2,
wherein, in a case of calculating the reliability using the low-bit criterion image, the motion vector information generation unit calculates the reliability based on angle information related to a luminance gradient of a block image.

6. The information processing apparatus according to claim 5,
wherein the motion vector information generation unit provides a higher reliability when variability in the angle information becomes less.

7. The information processing apparatus according to claim 2,
wherein, in a case of calculating a reliability based on the evaluation value and a reliability based on the low-bit criterion image, the motion vector information generation unit integrates the two reliabilities to provide one reliability.

8. The information processing apparatus according to claim 7,
wherein, in a case where the reliability based on the evaluation value and the reliability based on the low-bit criterion image are binary information, the motion vector information generation unit performs a logical operation of the two reliabilities to integrate the reliabilities, and, in a case where the reliability based on the evaluation value and the reliability based on the low-bit criterion image are multivalued information, the motion vector information generation unit multiplies the two reliabilities to integrate the reliabilities.

9. The information processing apparatus according to claim 1, further comprising:
a global motion vector calculation unit configured to calculate a global motion vector, which is one image-unit motion vector between the criterion image and the reference image, from the local motion vector and the reliability.

10. An information processing method comprising:
reducing a bit number assigned to a pixel in a criterion image and a reference image and generating a low-bit criterion image and a low-bit reference image; and
detecting a local motion vector, which is a motion vector for each of blocks constituting an image, from the low-bit criterion image and the low-bit reference image, and calculating a reliability of the detected local motion vector.

11. A program causing a computer to execute:
reducing a bit number assigned to a pixel in a criterion image and a reference image and generating a low-bit criterion image and a low-bit reference image; and
detecting a local motion vector, which is a motion vector for each of blocks constituting an image, from the low-bit criterion image and the low-bit reference image, and calculating a reliability of the detected local motion vector.
